(19) United States
(12) Patent Application Publication
(10) Pub. No.: US 2025/0297743 A1
(43) Pub. Date: Sep. 25, 2025

(54) COOKING APPLIANCE USING PROBE FOR TEMPERATURE DETECTION, AND METHOD FOR CONTROLLING SAME

(71) Applicant: SAMSUNG ELECTRONICS CO., LTD., Suwon-si (KR)

(72) Inventors: Seulkee LEE, Suwon-si (KR); Byungduck SEO, Suwon-si (KR); Kumchul HWANG, Suwon-si (KR)

(73) Assignee: SAMSUNG ELECTRONICS CO., LTD., Suwon-si (KR)

(21) Appl. No.: 19/227,886

(22) Filed: Jun. 4, 2025

Related U.S. Application Data
(63) Continuation of application No. PCT/KR2023/019270, filed on Nov. 27, 2023.

(30) Foreign Application Priority Data
Dec. 8, 2022 (KR) 10-2022-0170953

(51) Int. Cl. F24C 7/08; F24C 7/02; H05B 6/64

(52) U.S. Cl. CPC F24C 7/087; F24C 7/02; H05B 6/6452

(57) ABSTRACT

A method of controlling a cooking appliance, the method including obtaining an image captured by a camera arranged inside a cooking chamber of the cooking appliance, detecting, based on the captured image, a probe inserted into an object to be cooked that is placed inside the cooking chamber, performing a cooking operation on the object to be cooked, obtaining a probe temperature measurement value measured by the probe, determining whether a difference in value between a predicted probe temperature value, which is determined based on a type and an amount of the object to be cooked, and the measured probe temperature measurement value is greater than or equal to an error reference value, and based on the difference in value between the predicted probe temperature value and the probe temperature measurement value being greater than or equal to the error reference value, compensating the probe temperature measurement value.

### CROSS-REFERENCE TO RELATED APPLICATION(S)

This application is a continuation application, claiming priority under § 111(a), of International Application No. PCT/KR2023/019270, filed on Nov. 27, 2023, which is based on and claims the benefit of Korean Patent Application No.: 10-2022-0170953, filed Dec. 8, 2022, in the Korean Intellectual Property Office, the disclosures of which are incorporated by reference herein in their entireties.

### TECHNICAL FIELD

Embodiments of the present disclosure relate to a cooking appliance that uses a probe to detect the temperature of an object to be cooked. In addition, embodiments of the present disclosure relate to a method of controlling a cooking appliance, and a computer-readable recording medium having recorded thereon a program for causing a computer to perform the method of controlling a cooking appliance.

### BACKGROUND ART

Cooking appliances perform temperature control during a cooking process. For temperature control, a cooking appliance may measure the internal temperature of a cooking chamber and the temperature of an object to be cooked. The internal temperature of the object to be cooked may be measured by using a probe inserted into the object to be cooked. The probe may include a temperature sensor and may be inserted into the cooking chamber. A user may insert the probe appropriately into the object to be cooked, place the object to be cooked inside the cooking chamber, and carry out a cooking process. However, when the user does not appropriately insert the probe into the object to be cooked, the internal temperature of the object to be cooked may not be measured accurately.

### DISCLOSURE OF INVENTION

### Solution to Problem

According to an aspect of an embodiment of the present disclosure, a method of controlling a cooking appliance is provided. The method of controlling a cooking appliance includes obtaining an image captured by a camera arranged inside a cooking chamber of the cooking appliance. In addition, the method of controlling a cooking appliance includes detecting, based on the captured image, a probe inserted into an object to be cooked that is placed inside the cooking chamber. In addition, the method of controlling a cooking appliance includes performing a cooking operation on the object to be cooked. In addition, the method of controlling a cooking appliance includes obtaining a probe temperature measurement value measured by the probe. In addition, the method of controlling a cooking appliance includes determining whether a difference in value between a predicted probe temperature value, which is determined based on a type and an amount of the object to be cooked, and the measured probe temperature measurement value is greater than or equal to an error reference value. In addition, the method of controlling a cooking appliance includes, based on the difference in value between the predicted probe temperature value and the probe temperature measurement value being greater than or equal to the error reference value, compensating the probe temperature measurement value.

In addition, according to an aspect of an embodiment of the present disclosure, a cooking appliance is provided. The cooking appliance includes a cooking chamber that accommodates an object to be cooked. In addition, the cooking appliance includes a camera configured to photograph an interior of the cooking chamber. In addition, the cooking appliance 100 includes a communication module. In addition, the cooking appliance 100 includes a memory to store at least one instruction. In addition, the cooking appliance includes at least one processor. The at least one processor executes the at least one instruction to obtain an image captured by the camera. In addition, the at least one processor executes the at least one instruction to detect, based on the captured image, a probe inserted into the object to be cooked that is placed inside the cooking chamber. In addition, the at least one processor executes the at least one instruction to perform a cooking operation on the object to be cooked. In addition, the at least one processor executes the at least one instruction to obtain, through the communication module, a probe temperature measurement value measured by the probe. In addition, the at least one processor executes the at least one instruction to determine whether a difference in value between a predicted probe temperature value, which is determined based on a type and an amount of the object to be cooked, and the measured probe temperature measurement value is greater than or equal to an error reference value. In addition, the at least one processor executes the at least one instruction to compensate, based on the difference in value between the predicted probe temperature value and the measured probe temperature measurement value being greater than or equal to the error reference value, the probe temperature measurement value.

In addition, according to an aspect of an embodiment of the present disclosure, provided is a computer-readable recording medium having recorded thereon a program for causing a computer to perform the method of controlling a cooking appliance.

### BRIEF DESCRIPTION OF DRAWINGS

FIG. 1 is a diagram illustrating an operation of a cooking appliance according to an embodiment of the present disclosure.

FIG. 2 is a block diagram illustrating a structure of a cooking appliance according to an embodiment of the present disclosure.

FIG. 3 is a flowchart of a method of controlling a cooking appliance, according to an embodiment of the present disclosure.

FIG. 4 is a diagram illustrating a structure of a cooking appliance according to an embodiment of the present disclosure.

FIG. 5 is a diagram illustrating a process of setting a probe mode, according to an embodiment of the present disclosure.

FIG. 6 is a diagram illustrating a structure of a probe according to an embodiment of the present disclosure.

FIG. 7 is a diagram illustrating a process of setting a probe mode, according to an embodiment of the present disclosure.

FIG. 8 is a block diagram illustrating a structure of a cooking appliance according to an embodiment of the present disclosure.

FIG. 9 is a diagram illustrating a cooking appliance outputting a probe insertion guide, according to an embodiment of the present disclosure.

FIG. 10 is a diagram illustrating a cooking appliance, a user device, and a server, according to an embodiment of the present disclosure.

FIG. 11 is a diagram illustrating a process of outputting probe insertion guide information through a user device, according to an embodiment of the present disclosure.

FIG. 12 is a diagram showing predicted probe temperature values according to an embodiment of the present disclosure.

FIG. 13 is a diagram illustrating a process of obtaining a predicted probe temperature value in an automatic cooking mode, according to an embodiment of the present disclosure.

FIG. 14 is a diagram showing a lookup table of predicted probe temperature values corresponding to an automatic cooking item, according to an embodiment of the present disclosure.

FIG. 15 is a diagram showing a lookup table of error reference values, according to an embodiment of the present disclosure.

FIG. 16 is a diagram showing a process of compensating a probe temperature measurement value, according to an embodiment of the present disclosure.

FIG. 17 is a diagram illustrating a cooking appliance 100 outputting a probe temperature detection value, according to an embodiment of the present disclosure.

FIG. 18 is a diagram illustrating a probe temperature measurement value being output through a user device, according to an embodiment of the present disclosure.

FIG. 19 is a diagram illustrating a process of outputting probe insertion guide information, according to an embodiment of the present disclosure.

FIG. 20 is a diagram illustrating a lookup table of appropriate probe insertion depths, according to an embodiment of the present disclosure.

FIG. 21 is a diagram illustrating a process of outputting probe insertion guide information in an automatic cooking mode, according to an embodiment of the present disclosure.

FIG. 22 is a diagram illustrating a cooking appliance providing probe insertion guide information, according to an embodiment of the present disclosure.

FIG. 23 is a diagram illustrating a process in which a cooking appliance outputs probe insertion guide information, according to an embodiment of the present disclosure.

FIG. 24 is a diagram illustrating probe insertion guide information being output through a user device, according to an embodiment of the present disclosure.

FIG. 25 is a diagram illustrating a structure of a cooking appliance according to an embodiment of the present disclosure.

### MODE FOR THE INVENTION

It should be appreciated that various embodiments of the present disclosure and the terms used therein are not intended to limit the technological features set forth herein to particular embodiments, and include various changes, equivalents, or alternatives for a corresponding embodiment.

With regard to the description of the drawings, similar reference numerals may be used to refer to similar or related elements.

A singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, the term “and/or” includes any one or a combination of a plurality of related recited elements.

As used herein, such terms as “1st” and “2nd,” or “first” and “second” may be used to simply distinguish a corresponding component from another, and does not limit the components in other aspect (e.g., importance or order).

In the present disclosure, when an element (e.g., a first element) is referred to, with or without the term “operatively” or “communicatively”, as being “coupled with,” “coupled to,” “connected with,” or “connected to” another element (e.g., a second element), it means that the element may be connected to the other element directly (e.g., in a wired manner), wirelessly, or via a third element.

In the present disclosure, such terms as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof.

When an element is referred to as being “connected to,” “coupled to,” “supported by,” or “in contact with” another element, it means that the element is directly connected to, coupled to, supported by, or in contact with the other element, or that the element is indirectly connected to, coupled to, supported by, or in contact with the other element via a third element.

When an element is referred to as being “on” another element, it means that the element is in contact with the other element, or that still another element is present between the element and the other element.

Hereinafter, various embodiments of the present disclosure and the operating principle thereof will be described with reference to the accompanying drawings.

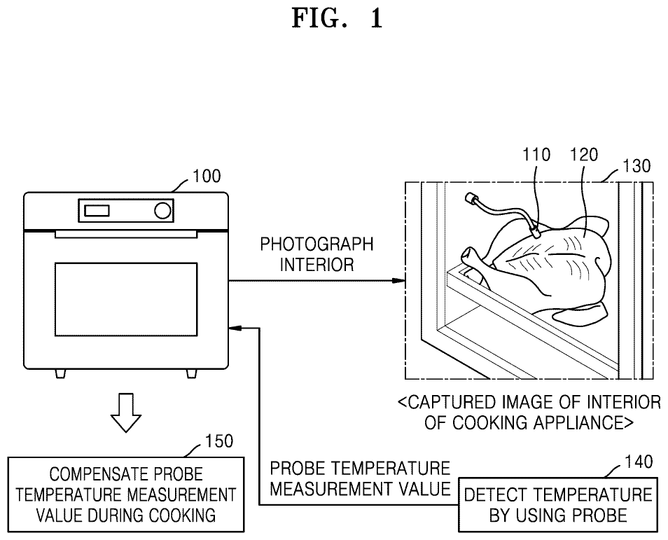

FIG. 1 is a diagram illustrating an operation of a cooking appliance according to an embodiment of the present disclosure.

According to an embodiment of the present disclosure, a cooking appliance 100 measures the internal temperature of an object 120 to be cooked by using a probe 110 for temperature detection. The cooking appliance 100 may determine whether the probe 110 is appropriately inserted into the object 120 to be cooked. In addition, when the probe 110 is not appropriately inserted into the object 120 to be cooked, the cooking appliance 100 may compensate 150 a probe temperature measurement value measured by the probe 110 and perform a cooking process by using the compensated probe temperature measurement value.

The cooking appliance 100 may include a camera. The cooking appliance 100 photographs the interior of the cooking chamber by using the camera. The cooking appliance 100 detects the probe 110 inserted into the object 120 to be cooked, from an image 130 captured by the camera. Upon detecting the probe 110 inside the cooking chamber, the cooking appliance 100 determines that the probe 110 has been inserted into the object 120 to be cooked, and performs a cooking operation using the probe 110.

In operation 140, while performing the cooking operation, the cooking appliance 100 measures the internal temperature of the object 120 to be cooked by using the probe 110. The probe temperature measurement value measured by the probe 110 corresponds to the internal temperature of the object 120 to be cooked.

The cooking appliance 100 compares the probe temperature measurement value with a predicted probe temperature value. When the difference between the probe temperature measurement value and the predicted probe temperature value is greater than or equal to a predetermined error reference value, the cooking appliance 100 compensates the probe temperature measurement value. The cooking appliance 100 may perform the cooking operation based on the compensated probe temperature measurement value.

According to an embodiment of the present disclosure, in a case in which a cooking operation is performed by using a probe temperature measurement value measured by the probe 110, compensating the probe temperature measurement value by using a predetermined predicted probe temperature value allows for more accurate temperature control and cooking operation. The value measured by the probe 110 may vary depending on the method, depth, position, etc. of insertion of the probe 110 into the object 120 to be cooked. However, when a user directly inserts the probe 110 into the object 120 to be cooked, improper insertion in terms of method, depth, position, or the like may occur, potentially leading to inaccurate measurement of the internal temperature of the object 120 to be cooked by the probe 110. According to an embodiment of the present disclosure, by compensating a probe temperature measurement value using a predicted probe temperature value, the cooking appliance 100 may achieve more accurate temperature measurement with the probe 110 during a cooking process.

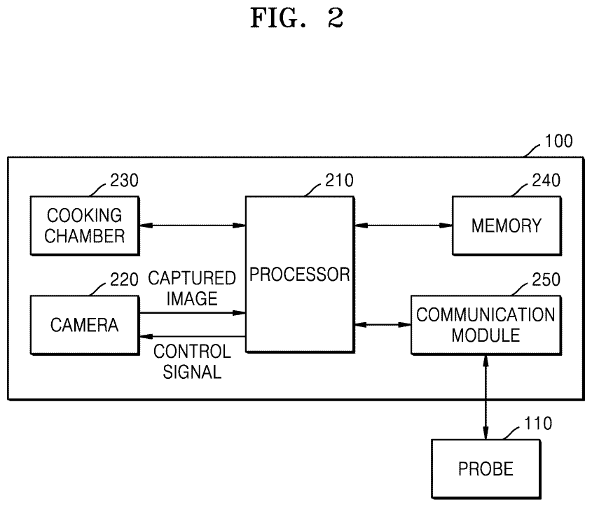

FIG. 2 is a block diagram illustrating a structure of a cooking appliance according to an embodiment of the present disclosure.

The cooking appliance 100 according to an embodiment of the present disclosure encompasses various types of cooking appliance 100 that perform cooking in a high-temperature environment or induce heat generation in food ingredients to perform cooking. The cooking appliance 100 may be implemented in the form of, for example, an oven, a microwave oven, an air fryer, a smart cooker, or a toaster.

According to an embodiment of the present disclosure, the cooking appliance 100 may include a processor 210, a camera 220, a cooking chamber 230, a memory 240, and a communication module 250.

The processor 210 controls the overall operation of the cooking appliance 100. The processor 210 may be implemented as one or more processors. The processor 210 may execute instructions or commands stored in the memory 240 to perform predetermined operations. In addition, the processor 210 controls the operation of components provided in the cooking appliance 100. The processor 210 may include at least one of a central processing unit (CPU), a graphics processing unit (GPU), or a neural processing unit (NPU), or a combination thereof.

The camera 220 photoelectrically converts incident light to generate an electrical image signal. The camera 220 may include at least one lens, a lens driver, and an image sensor. The camera 220 may be arranged to photograph the interior of the cooking chamber 230. For example, the camera 220 may be arranged on the ceiling of the cooking chamber, a door 410 of the cooking chamber, a side surface of the cooking chamber, or the like. The camera 220 may include one or more cameras 220. The camera 220 generates captured image data and outputs it to the processor 210.

The processor 210 controls a photographing operation of the camera 220 according to an operation mode. According to an embodiment, the processor 210 controls the camera 220 to photograph the interior of the cooking chamber while the cooking appliance 100 is performing a cooking operation. The processor 210 initiates a cooking operation based on a user input requesting the start of cooking, and may start photographing of the camera 220 according to the cooking start request.

The captured image includes a still image or a moving image. According to an embodiment of the present disclosure, the captured image may correspond to a real-time moving image of the interior of the cooking chamber taken during a cooking operation. In addition, according to an embodiment of the present disclosure, the captured image may correspond to a still image of the interior of the cooking chamber taken at predetermined time intervals during a cooking operation. In addition, according to an embodiment of the present disclosure, the captured image may correspond to a still image or a moving image of the interior of the cooking chamber taken based on a user input.

The image captured by the camera 220 may be, for example, an image compressed in a format such as H.264 or JPEG. In a case in which the captured image is a compressed image, the processor 210 generates a captured image in a format such as YUV or RGB through a decoding process.

The cooking chamber 230 corresponds to a cooking space for accommodating food ingredients. The cooking chamber 230 includes a space formed by a partition that is isolated from the outside. The cooking chamber 230 includes a tray or a shelf on which food ingredients may be placed. The cooking chamber 230 may be insulated by a heat insulating member to block internal heat. According to an embodiment, the cooking appliance 100 may output heat from a heating device to the cooking chamber 230 to perform a cooking operation inside the cooking chamber 230. In addition, according to an embodiment, the cooking appliance 100 may output microwaves from a microwave output device to the cooking chamber 230 to perform a cooking operation inside the cooking chamber 230.

According to an embodiment, the cooking chamber 230 may be opened or isolated from the outside by an openable and closable door. In addition, according to an embodiment, the cooking chamber 230 may correspond to a drawer-type basket, and may be opened or isolated from the outside by insertion and extraction operations of the basket.

The processor 210 obtains an image of the interior of the cooking chamber captured by the camera 220. The processor 210 detects the probe 110 inserted into the object 120 to be cooked inside the cooking chamber based on the captured image.

According to an embodiment of the present disclosure, the processor 210 may detect the probe 110 from the captured image by using a certain visual indicator provided on the probe 110. The visual indicator may correspond to, for example, a visual code (e.g., a barcode or a Quick Response (QR)), an indicator of a certain shape, etc. The processor 210 may detect the probe 110 by recognizing the visual indicator provided at a certain position on the surface of the probe 110 from the captured image. According to an embodiment of the present disclosure, the visual indicator may be positioned such that it is not inserted into the object 120 to be cooked when the probe 110 is inserted into the object 120 to be cooked. For example, the visual indicator may be arranged near a handle of the probe 110.

In addition, according to an embodiment of the present disclosure, the processor 210 may detect the probe 110 by recognizing the probe 110 itself from the captured image. The processor 210 may detect the probe 110 by recognizing the shape of the probe 110 from the captured image.

The memory 240 stores various pieces of information, data, instructions, programs, and the like necessary for the operation of the cooking appliance 100. The memory 240 may include at least one of volatile memory or nonvolatile memory, or a combination thereof. The memory 240 may include at least one of a flash memory-type storage medium, a hard disk-type storage medium, a multimedia card micro-type storage medium, a card-type memory (e.g., Secure Digital (SD) or extreme Digital (XD) memory), random-access memory (RAM), static RAM (SRAM), read-only memory (ROM), electrically erasable programmable ROM (EEPROM), programmable ROM (PROM), magnetic memory, a magnetic disk, and an optical disc. In addition, the memory 240 may correspond to a web storage or a cloud server that performs a storage function on the Internet.

The communication module 250 receives a probe temperature measurement value from the probe 110. The communication module 250 may be connected to the probe 110 by wire or wirelessly.

According to an embodiment of the present disclosure, the communication module 250 may include an input terminal connected to a communication line of the probe 110. When the communication line of the probe 110 is connected to the input terminal, the communication module 250 may receive, from the probe 110, a probe temperature detection value detected by the probe 110.

According to an embodiment of the present disclosure, the communication module 250 may communicate wirelessly with the probe 110 by using short-range wireless communication. For example, the communication module 250 may communicate with the probe 110 by using Bluetooth, Bluetooth Low Energy (BLE), near-field communication, wireless local area network (WLAN) (Wi-Fi), Zigbee, Infrared Data Association (IrDA) communication, Wi-Fi Direct (WFD), ultra-wideband (UWB), Ant+ communication, etc. The communication module 250 may establish short-range wireless communication with the probe 110 and receive a probe temperature detection value from the probe 110.

In addition, the communication module 250 may communicate with an external device such as a server, a mobile device, or a user device, by wire or wirelessly. The communication module 250 may access an access point (AP) device to transmit and receive Wi-Fi signals. The processor 210 may control transmission and reception operations of the communication module 250.

The communication module 250 may include a wireless communication module (e.g., a cellular communication module, a short-range wireless communication module, or a global navigation satellite system (GNSS) communication module) or a wired communication module (e.g., a local area network (LAN) communication module or a power line communication module). In addition, the communication module 250 may perform short-range communication, and may use, for example, Bluetooth, BLE, NFC, WLAN (Wi-Fi), Zigbee, IrDA communication, WFD, UWB, Ant+ communication, etc. In addition, for example, the communication module 250 may perform long-range communication, and may communicate with an external device through, for example, a legacy cellular network, a 5G network, a next-generation communication network, the Internet, a computer network (e.g., a LAN or a WAN), or the like.

In addition, for example, the communication module 250 may use mobile communication, and may transmit and receive wireless signals to and from at least one of a base station, an external terminal, and a server, on a mobile communication network.

According to an embodiment, the communication module 250 is connected to an AP inside a home through Wi-Fi communication. The communication module 250 may communicate with an external device through the AP.

The processor 210 obtains a probe temperature measurement value from the probe 110 through the communication module 250. The probe 110 includes a temperature sensor, and outputs a probe temperature measurement value generated by the temperature sensor to the cooking appliance 100. The communication module 250 receives the probe temperature measurement value from the probe 110 and transmits it to the processor 210. The processor 210 obtains a probe temperature measurement value from the probe 110 in real time.

The processor 210 compares the probe temperature measurement value with a predicted probe temperature value, and compensates the probe temperature measurement value when necessary.

The cooking appliance 100 stores a predicted probe temperature value in the memory 240. The predicted probe temperature value may be determined based on at least one of the type of an object to be cooked, the amount of the object to be cooked, a room temperature/refrigerated/frozen state of the object to be cooked, a cooking time, or the internal temperature of the cooking chamber. The processor 210 may obtain information about at least one of the type of the object to be cooked, the amount of the object to be cooked, or the room temperature/refrigerated/frozen state based on a user input. In addition, the processor 210 may obtain cooking time information by counting the time after the start of the cooking operation. In addition, the processor 210 may obtain the internal temperature of the cooking chamber from a temperature sensor configured to measure the internal temperature of the cooking chamber.

The processor 210 obtains a predicted probe temperature value based on at least one of the type of the object to be cooked, the amount of the object to be cooked, the room temperature/refrigerated/frozen state of the object to be cooked, the cooking time, or the internal temperature of the cooking chamber. The processor 210 may obtain the cooking time or the internal temperature of the cooking chamber in real time, to obtain a predicted probe temperature value periodically.

The processor 210 compares the probe temperature measurement value with the predicted probe temperature value. The processor 210 determines whether the difference between the probe temperature measurement value and the predicted probe temperature value is greater than or equal to a predetermined error reference value. When the difference between the probe temperature measurement value and the predicted probe temperature value is greater than or equal to the error reference value, the processor 210 compensates the probe temperature measurement value. According to an embodiment of the present disclosure, the processor 210 may compensate the probe temperature measurement value by changing the probe temperature measurement value to the predicted probe temperature value. When the difference between the probe temperature measurement value and the predicted probe temperature value is less than the error reference value, the processor 210 uses the probe temperature measurement value as it is without compensating it.

After the cooking operation of the cooking appliance 100 starts, the processor 210 may determine whether to compensate the probe temperature measurement value, and may perform the cooking operation based on the probe temperature measurement value. In addition, the processor 210 may determine whether to compensate the probe temperature detection value, only in a certain operation mode. For example, in a probe mode in which a cooking operation is performed by using the probe 110, the processor 210 may perform a compensation operation on the probe temperature detection value. In addition, for example, in an automatic cooking mode in which automatic cooking is performed by using certain food ingredients, the processor 210 may perform a compensation operation on the probe temperature detection value.

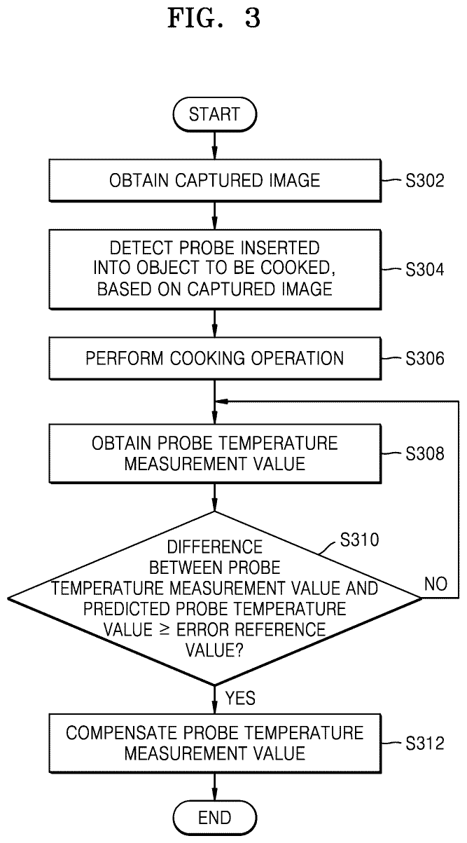

FIG. 3 is a flowchart of a method of controlling a cooking appliance, according to an embodiment of the present disclosure.

According to an embodiment of the present disclosure, a method of controlling a cooking appliance may be performed by the cooking appliance 100 of the present disclosure.

In operation S302, the cooking appliance 100 photographs the interior of the cooking chamber by using the camera 220 configured to photograph the interior of the cooking chamber, and obtains a captured image. The cooking appliance 100 may photograph the interior of the cooking chamber in real time to obtain a captured image.

Next, in operation S304, the cooking appliance 100 detects the probe 110 inserted into the object 120 to be cooked, based on the captured image. The cooking appliance 100 may detect the probe 110 by recognizing an object in the captured image. According to an embodiment of the present disclosure, the cooking appliance 100 may detect the probe 110 from the captured image by using a certain visual indicator provided on the probe 110. In addition, according to an embodiment of the present disclosure, the cooking appliance 100 the probe 110 by recognizing the probe 110 itself from the captured image.

Next, in operation S306, the cooking appliance 100 performs a cooking operation. The cooking appliance 100 performs the cooking operation based on a user input. In addition, the cooking appliance 100 performs the cooking operation at a target cooking chamber temperature that is set by a user input. For example, the target cooking chamber temperature may be directly defined by a user input. In addition, for example, the target cooking chamber temperature may be defined by the cooking appliance 100 based on a cooking mode selected by the user. The cooking appliance 100 performs a temperature control operation to regulate the internal temperature of the cooking chamber to be equal to the target cooking chamber temperature during the cooking operation. The cooking appliance 100 performs the temperature control operation by heating the interior of the cooking chamber or by stopping the heating.

Next, in operation S308, the cooking appliance 100 obtains a probe temperature measurement value. The cooking appliance 100 obtains the probe temperature measurement value from the probe 110 in real time.

Next, in operation S310, the cooking appliance 100 determines whether the difference between the probe temperature measurement value and a predicted probe temperature value is greater than or equal to an error reference value. The cooking appliance 100 stores information about the predicted probe temperature value in a memory. The predicted probe temperature value may be determined based on at least one of the type of an object to be cooked, the amount of the object to be cooked, a room temperature/refrigerated/frozen state of the object to be cooked, a cooking time, or the internal temperature of the cooking chamber. The cooking appliance 100 obtains a predicted probe temperature value based on at least one of the type of the object to be cooked, the amount of the object to be cooked, the room temperature/refrigerated/frozen state of the object to be cooked, the cooking time, or the internal temperature of the cooking chamber. The cooking appliance 100 determines whether the difference between the probe temperature measurement value and the predicted probe temperature value is greater than or equal to a predetermined error reference value.

Next, in operation S312, when the difference between the probe temperature measurement value and the predicted probe temperature value is greater than or equal to the error reference value, the cooking appliance 100 compensates the probe temperature measurement value. According to an embodiment of the present disclosure, the cooking appliance 100 may compensate the probe temperature measurement value by changing the probe temperature measurement value to the predicted probe temperature value.

In operation S310, when the difference between the probe temperature measurement value and the predicted probe temperature value is less than the error reference value, the cooking appliance 100 uses the probe temperature measurement value as it is without compensating it.

The cooking appliance 100 may periodically repeat operations S308, S310, and S312 while performing the cooking operation. The cooking appliance 100 may obtain the probe temperature measurement value in real time in operation S308, and perform operations S310 and S312.

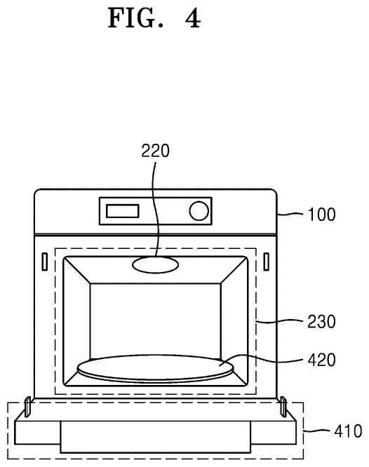

FIG. 4 is a diagram illustrating a structure of a cooking appliance according to an embodiment of the present disclosure.

According to an embodiment of the present disclosure, the cooking appliance 100 may be opened and isolated from the outside by opening and closing of the door 410. The cooking chamber 230 may accommodate food ingredients in an internal space. The cooking chamber 230 may include a tray 420 on which food ingredients may be placed.

The camera 220 may be arranged on the ceiling of the cooking chamber 230 to photograph a cooking process of food ingredients placed in the cooking chamber 230.

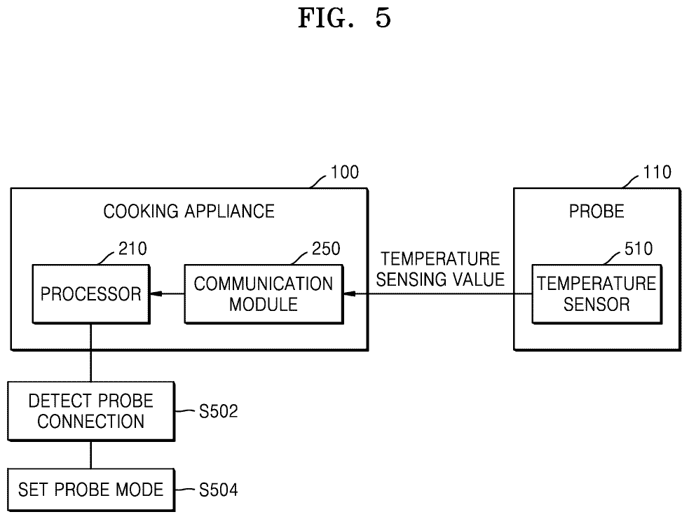

FIG. 5 is a diagram illustrating a process of setting a probe mode, according to an embodiment of the present disclosure.

According to an embodiment of the present disclosure, based on detecting a connection with the probe 110 in operation S502, the cooking appliance 100 sets the probe mode in operation S504. The probe mode is a mode in which the internal temperature of an object to be cooked is detected by using the probe 110 (temperature sensor 510) and a cooking operation is performed based on a probe temperature detection value. When operating in the probe mode, the cooking appliance 100 performs operations such as obtaining a probe temperature detection value, controlling a cooking operation based on the probe temperature detection value, or outputting the probe temperature detection value.

According to an embodiment of the present disclosure, in the probe mode, the cooking appliance 100 performs a compensation operation on a probe temperature detection value. In addition, based on operating in the probe mode, the cooking appliance 100 obtains a predicted probe temperature value, and when the difference between the probe temperature detection value and the predicted probe temperature value is greater than or equal to an error reference value, compensates the probe temperature detection value.

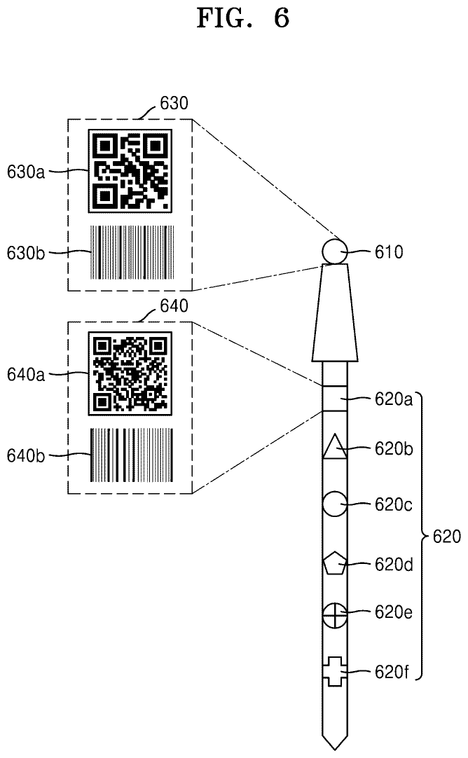

FIG. 6 is a diagram illustrating a structure of a probe according to an embodiment of the present disclosure.

According to an embodiment of the present disclosure, the probe 110 includes a probe identifier 610 and a depth identifier 620, on a surface thereof. The probe identifier 610 and the depth identifier 620 are provided on the outer surface of the probe 110 so as to be recognizable by the naked eye.

The probe identifier 610 indicates that the object corresponds to the probe 110. The probe identifier 610 is arranged to be located outside the object 120 to be cooked even when the probe 110 is inserted into the object 120 to be cooked. For example, the probe identifier 610 may be arranged at the upper end of the probe 110.

The depth identifier 620 is provided on a protruding portion of the probe 110, and the protruding portion is to be inserted into the object to be cooked. The depth identifier 620 includes a plurality of depth identifiers 620a, 620b, 620c, 620d, 620e, and 620f. The number and intervals of the plurality of depth identifiers 620a, 620b, 620c, 620d, 620e, and 620f may be variously set. The plurality of depth identifiers 620a, 620b, 620c, 620d, 620e, and 620f are arranged at different depth points on the protruding portion of the probe 110. For example, the plurality of depth identifiers 620a, 620b, 620c, 620d, 620e, and 620f may be arranged at intervals of 2 cm on the protruding portion of the probe 110.

The plurality of depth identifiers 620a, 620b, 620c, 620d, 620e, and 620f are provided to be distinguishable from each other by the naked eye. For example, the plurality of depth identifiers 620a, 620b, 620c, 620d, 620e, and 620f may have different shapes or colors to allow the user to distinguish between the plurality of depth identifiers 620a, 620b, 620c, 620d, 620e, and 620f by the naked eye. In addition, for example, the plurality of depth identifiers 620a, 620b, 620c, 620d, 620e, and 620f may include text or numbers to allow the user to distinguish between the plurality of depth identifiers 620a, 620b, 620c, 620d, 620e, and 620f by the naked eye. In addition, for example, the plurality of depth identifiers 620a, 620b, 620c, 620d, 620e, and 620f may correspond to a plurality of scale marks to allow the user to distinguish between the plurality of depth identifiers 620a, 620b, 620c, 620d, 620e, and 620f by identifying the position of each scale mark by the naked eye.

According to an embodiment of the present disclosure, the probe identifier 610 includes a probe identifier visual code 630. The probe identifier visual code 630 may correspond to, for example, a QR code 630a or a barcode 630b. The probe identifier visual code 630 may be visible to the naked eye or may not be visible to the naked eye. In a case in which the probe identifier visual code 630 is not visible to the naked eye, the probe identifier visual code 630 is provided to be recognizable by the camera 220 of the cooking appliance 100.

In addition, according to an embodiment of the present disclosure, each of the plurality of depth identifiers 620a, 620b, 620c, 620d, 620e, and 620f includes a depth identifier visual code 640. A plurality of depth identifier visual codes 640 corresponding to the plurality of depth identifiers 620a, 620b, 620c, 620d, 620e, and 620f, respectively, may be provided to be distinguishable from each other. The depth identifier visual code 640 may correspond to, for example, a QR code 640a or a barcode 640b. The depth identifier visual code 640 may be visible to the naked eye or may not be visible to the naked eye. In a case in which the depth identifier visual code 640 is not visible to the naked eye, the depth identifier visual code 640 is provided to be recognizable by the camera 220 of the cooking appliance 100.

The cooking appliance 100 may recognize the depth to which the probe 110 is inserted into the object 120 to be cooked, by recognizing the plurality of depth identifiers 620a, 620b, 620c, 620d, 620e, and 620f from a captured image. For example, when the depth identifiers 620a and 620b are recognized from the captured image and the depth identifiers 620c, 620d, 620e, and 620f are not recognized, the cooking appliance 100 determines that the probe 110 has been inserted into the object 120 to be cooked to a depth between the depth identifiers 620b and 620c. Therefore, according to an embodiment of the present disclosure, there is an effect that the insertion depth of the probe 110 may be recognized by using an image captured by the camera 220.

In addition, the user may easily recognize the insertion depth by using the plurality of depth identifiers 620a, 620b, 620c, 620d, 620e, and 620f that are visible to the naked eye. In addition, the cooking appliance 100 may guide the user to easily insert the probe 110 into the object 120 to be cooked to an appropriate depth, by providing guide information about a cooking operation by using the plurality of depth identifiers 620a, 620b, 620c, 620d, 620e, and 620f that are visible to the naked eye.

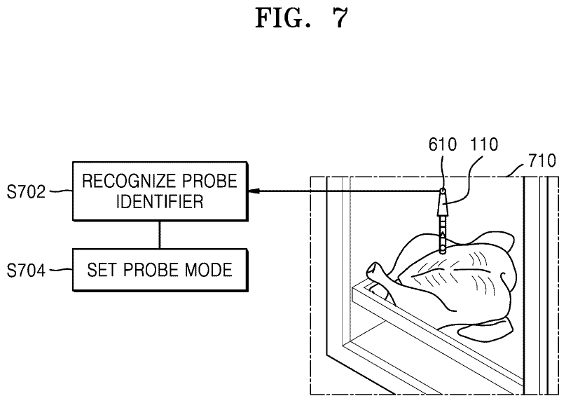

FIG. 7 is a diagram illustrating a process of setting a probe mode, according to an embodiment of the present disclosure.

According to an embodiment of the present disclosure, in operation S702, the cooking appliance 100 recognizes the probe identifier 610 from a captured image 710. The probe identifier 610 is a visual indicator arranged at a certain position on the probe 110. The probe identifier 610 may include information indicating that the object corresponds to the probe 110. The cooking appliance 100 recognizes the probe identifier 610 by using an algorithm for recognizing an object in an image.

As described above with reference to FIG. 6, the probe identifier 610 may include a visual code. For example, the probe identifier 610 includes a barcode or a QR code. The cooking appliance 100 may recognize the probe identifier 610 by recognizing the visual code of the probe identifier 610.

In operation S704, upon recognizing the probe identifier 610 from the captured image 710, the cooking appliance 100 operates in the probe mode. According to an embodiment of the present disclosure, in the probe mode, the cooking appliance 100 performs a compensation operation on a probe temperature detection value. In addition, based on operating in the probe mode, the cooking appliance 100 obtains a predicted probe temperature value, and when the difference between a probe temperature detection value and the predicted probe temperature value is greater than or equal to an error reference value, compensates the probe temperature detection value.

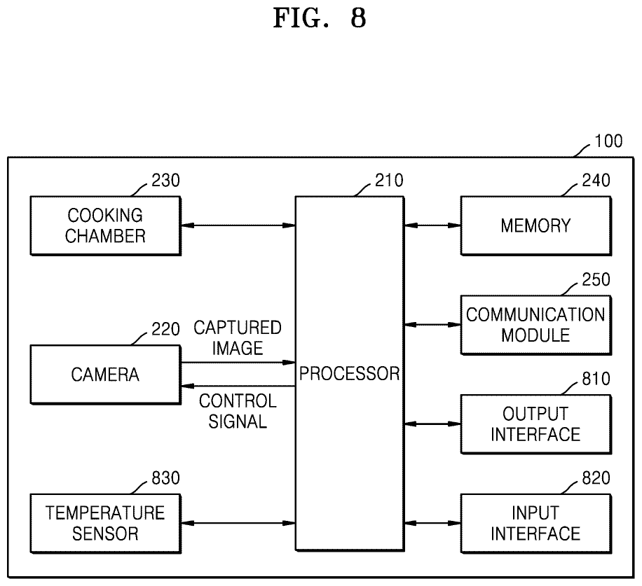

FIG. 8 is a block diagram illustrating a structure of a cooking appliance according to an embodiment of the present disclosure.

According to an embodiment of the present disclosure, the cooking appliance 100 may include the processor 210, the camera 220, the cooking chamber 230, the memory 240, the communication module 250, an output interface 810, an input interface 820, and a temperature sensor 830. FIG. 8 will be described focusing on the differences from the cooking appliance 100 illustrated in FIG. 2.

The output interface 810 outputs information and data associated with an operation of the cooking appliance 100. The output interface 810 may include, for example, a display, a speaker, or a light-emitting diode (LED).

According to an embodiment of the present disclosure, the processor 210 may output information such as probe insertion guide information or probe insertion depth guide information, through the output interface 810. The probe insertion guide information is information that guides the user to insert the probe 110 into an object to be cooked. The probe insertion depth guide information is information that guides through how deep the probe 110 needs to be inserted when inserting the probe 110 into an object to be cooked.

The input interface 820 receives a user input. The input interface 820 may include a key, a touch panel, a touch screen, a dial, a button, etc.

According to an embodiment of the present disclosure, the processor 210 may receive information about an object to be cooked, target cooking chamber temperature information, automatic cooking setting information, and the like, through the input interface 820. The information about the object to be cooked includes at least one of the type of the object to be cooked or the amount of the object to be cooked. The target cooking chamber temperature information includes a target internal temperature of the cooking chamber 230 during a cooking operation. The automatic cooking setting information is information that requests the cooking appliance 100 to automatically perform a cooking operation according to the type of dish or the type of the object to be cooked.

The temperature sensor 830 detects the temperature of the cooking chamber 230 of the cooking appliance 100. The temperature sensor 830 measures the temperature and converts it into an electrical signal. The temperature sensor 830 may be arranged inside the cooking chamber 230. The temperature sensor 830 outputs a measured temperature detection value to the processor 210.

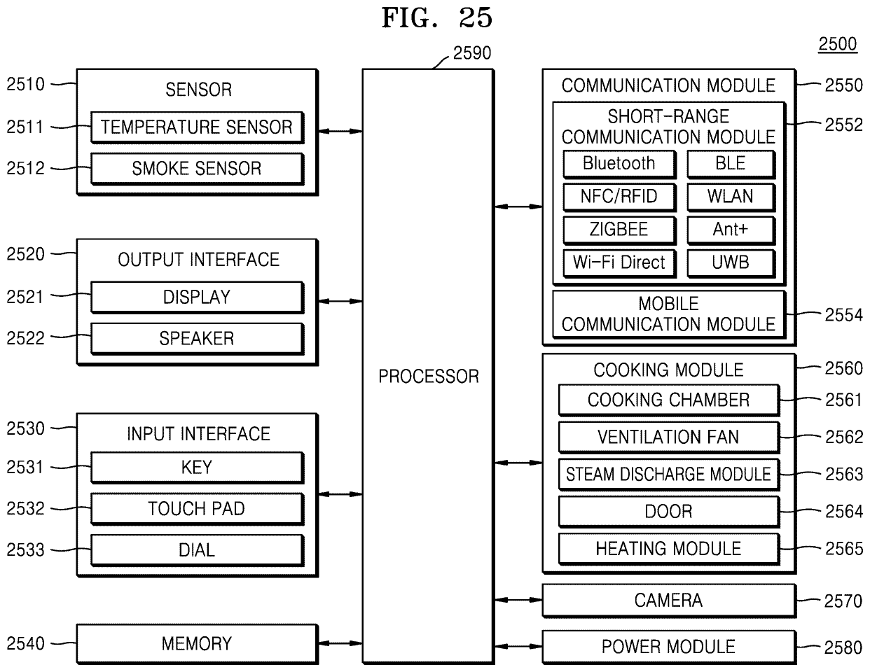

The processor 210 regulates the internal temperature of the cooking chamber 230 to be equal to the target cooking chamber temperature, based on the internal temperature of the cooking chamber detected by the temperature sensor 830. The processor 210 performs control of the internal temperature of the cooking chamber 230 by heating the interior of the cooking chamber 230 by using a heating module 2565 (see FIG. 25) configured to heat the interior of the cooking chamber 230, and controlling the heating intensity and on/off state of the heating module 2565 based on the internal temperature of the cooking chamber.

According to an embodiment of the present disclosure, when operating in the probe mode, the processor 210 performs temperature control based on a probe temperature measurement value measured by the probe 110 and an internal temperature of the cooking chamber measured by the temperature sensor 830. The processor 210 regulates the internal temperature of the object to be cooked based on the probe temperature measurement value, and regulates the internal temperature of the cooking chamber based on the internal temperature of the cooking chamber. The temperature control method based on the probe temperature measurement value and the internal temperature of the cooking chamber may be variously determined.

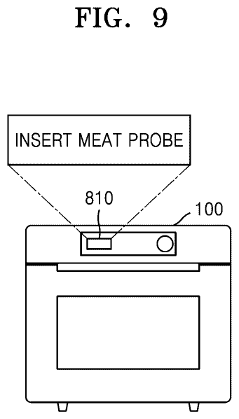

FIG. 9 is a diagram illustrating a cooking appliance outputting a probe insertion guide, according to an embodiment of the present disclosure.

According to an embodiment of the present disclosure, the cooking appliance 100 outputs probe insertion guide information through the output interface 810. When temperature measurement using the probe 110 is required in a certain cooking mode, the cooking appliance 100 outputs probe insertion guide information. Modes in which temperature measurement using the probe 110 is required may include, for example, an automatic cooking mode, a baking mode, a meat cooking mode, and a fish grilling mode.

In a mode that requires temperature measurement using the probe 110, the processor 210 determines whether the probe 110 is inserted into an object to be cooked. The processor 210 may recognize the probe 110 from a captured image to determine whether the probe 110 is inserted into the object to be cooked. In a mode that requires temperature measurement using the probe 110, when the probe 110 is not inserted into the object to be cooked, the processor 210 may output probe insertion guide information through the output interface 810. Upon determining that the probe 110 is inserted into the object to be cooked, the processor 210 may stop the output of the probe insertion guide information.

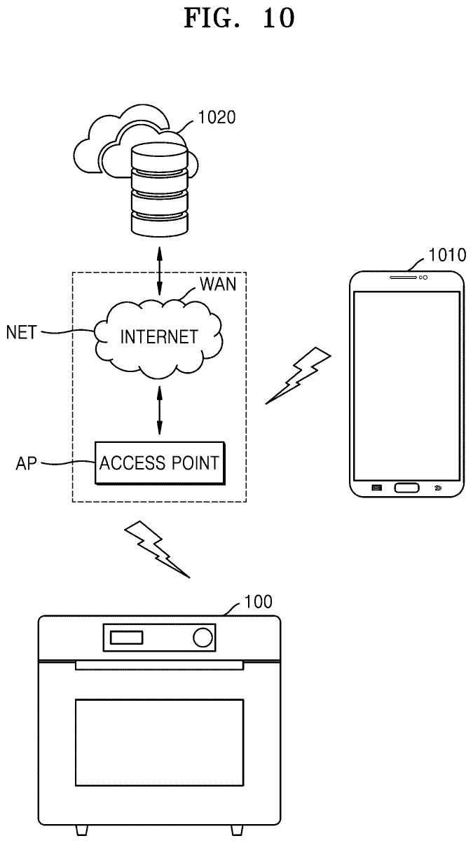

FIG. 10 is a diagram illustrating a cooking appliance, a user device, and a server, according to an embodiment of the present disclosure.

According to an embodiment of the present disclosure, the cooking appliance 100 communicates with a user device 1010 and a server 1020 through the communication module 250. The cooking appliance 100 may be connected to other home appliances, the user device 1010, or the server 1020 through a network NET.

The server 1020 may manage information about a user account and information about the cooking appliance 100 linked to the user account. For example, the user may access the server 1020 through the user device 1010 to create a user account. The user account may be identified by an identifier (ID) and a password both set by the user. The server 1020 may register the cooking appliance 100 in the user account according to a preset procedure. For example, the server 1020 may register the cooking appliance 100 by associating identification information of the cooking appliance 100 (e.g., a serial number or a medium access control (MAC) address) with the user account.

The user device 1010 may include a communication module capable of communicating with the cooking appliance 100 and the server 1020, a user interface configured to receive a user input or output information to the user, at least one processor configured to control the operation of the cooking appliance 100, and at least one memory storing a program for controlling the operation of the cooking appliance 100.

The user device 1010 may be carried by the user or placed in the user's home or office. The user device 1010 may include, for example, a personal computer, a terminal, a portable telephone, a smart phone, a handheld device, or a wearable device, but is not limited thereto.

A program (e.g., an application) for controlling the cooking appliance 100 may be stored in the memory of the user device 1010. The user device 1010 may be sold with an application for controlling the cooking appliance 100 installed therein, or may be sold without the application. In a case in which the user device 1010 is sold without an application for controlling the cooking appliance 100, the user may download the application from an external server that provides applications, and install the application on the user device 1010.

The user may control the cooking appliance 100 by using the application installed on the user device 1010. For example, when the user executes the application installed on the user device 1010, identification information of the cooking appliance 100 linked to the same user account as the user device 1010 may be shown in an application execution window. The user may perform desired control on the cooking appliance 100 through the application execution window. When the user inputs a control command for the cooking appliance 100 through the application execution window, the user device 1010 may transmit the control command directly to the cooking appliance 100 through a network, or may transmit the control command to the cooking appliance 100 via the server 1020.

The network NET may include both a wired network and a wireless network. The wired network includes a cable network or a telephone network, and the wireless network may include any network for transmitting and receiving signals through radio waves. The wired network and the wireless network may be connected to each other.

The network NET may include a WAN such as the Internet, a LAN configured around an AP, and a wireless personal area network (WPAN) that does not go through an AP. The short-range wireless network may include Bluetooth™ (Institute of Electrical and Electronics Engineers (IEEE) 802.15.1), Zigbee (IEEE 802.15.4), WFD, near-field communication (NFC), Z-Wave, and the like, but is not limited thereto.

The AP may connect a LAN to which the cooking appliance 100 and the user device 1010 are connected, to a WAN to which the server 1020 is connected. The cooking appliance 100 or the user device 1010 may be connected to the server 1020 through the WAN.

The AP may communicate with the cooking appliance 100 and the user device 1010 by using wireless communication such as Wi-Fi™ (IEEE 802.11), and may connect to a WAN by using wired communication.

The cooking appliance 100 may transmit information about an operation or a state to the server 1020 through the network NET. For example, the cooking appliance 100 may transmit information about an operation or a state to the server 1020 through Wi-Fi™ (IEEE 802.11) communication. In a case in which the cooking appliance 100 does not include a Wi-Fi communication module, the cooking appliance 100 may transmit information about an operation or a state to the server 1020 through another home appliance having a Wi-Fi communication module. For example, when the cooking appliance 100 transmits information about an operation or a state to another home appliance through a short-range wireless network (e.g., BLE communication), the other home appliance may transmit the information about the operation or state of the cooking appliance 100 to the server 1020. The cooking appliance 100 may provide information about an operation or a state of the cooking appliance 100 to the server 1020 according to the user's prior approval. Information transmission to the server 1020 may occur when a request is received from the server 1020, may occur when a particular event occurs in the cooking appliance 100, or may occur periodically or in real time.

Upon receiving information about an operation or a state from the cooking appliance 100, the server 1020 may update previously stored information related to the cooking appliance 100. The server 1020 may transmit information about an operation or a state of the cooking appliance 100 to the user device 1010 through the network NET. When a request is received from the cooking appliance 100, the server 1020 may transmit information about an operation or a state of the cooking appliance 100 to the user device 1010. For example, when the user executes, on the user device 1010, an application connected to the server 1020, the user device 1010 may request and receive information about an operation or a state of the cooking appliance 100 from the server 1020 through the application. When information about an operation or a state is received from the cooking appliance 100, the server 1020 may transmit the information about the operation or state of the cooking appliance 100 to the user device 1010 in real time. For example, upon receiving, from the cooking appliance 100, information that an operation of the cooking appliance 100 has been completed, the server 1020 may transmit the information that the operation of the cooking appliance 100 has been completed, to the user device 1010 in real time through an application installed on the user device 1010. The server 1020 may periodically transmit information about an operation or a state of the cooking appliance 100 to the user device 1010. The user device 1010 may deliver information about an operation or a state of the cooking appliance 100 to the user by displaying the information about the operation or state of the cooking appliance 100 on an application execution window.

The cooking appliance 100 may obtain various pieces of information from the server 1020 and provide the obtained information to the user. For example, the cooking appliance 100 may obtain information, such as recipes or weather, from the server 1020 and output the obtained information through the output interface 810. The cooking appliance 100 may receive, from the server 1020, a file for updating previously installed software or data associated with the previously installed software, and update the previously installed software or the data related to the previously installed software based on the received file.

The cooking appliance 100 may operate according to a control command received from the server 1020. For example, upon obtaining prior approval from the user to operate according to a control command of the server 1020 even without a user input, the cooking appliance 100 may operate according to a control command received from the server 1020. The control command received from the server 1020 may include a control command input by the user through the user device 1010 or a control command generated by the server 1020 based on a preset condition, but is not limited thereto.

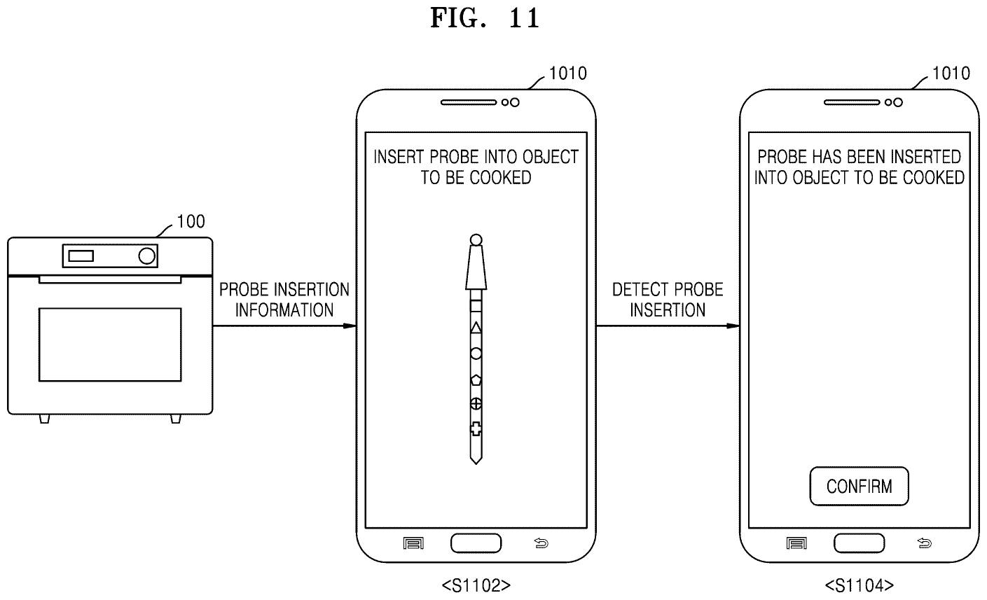

FIG. 11 is a diagram illustrating a process of outputting probe insertion guide information through a user device, according to an embodiment of the present disclosure.

According to an embodiment of the present disclosure, in operation S1102, probe insertion guide information may be output through an application of the user device 1010. Through the application, the user device 1010 may control a cooking operation or receive and output information about the cooking operation from the server 1020. When the cooking mode of the cooking appliance 100 is a mode that requires insertion of the probe 110, the user device 1010 may output probe insertion guide information. The user device 1010 may receive information about whether the cooking mode is a mode that requires insertion of the probe 110, from the cooking appliance 100 through the server 1020.

In addition, the user device 1010 outputs probe insertion guide information based on probe insertion information. The user device 1010 may receive probe insertion information obtained by the cooking appliance 100. The probe insertion information is information indicating whether the probe 110 is inserted into an object to be cooked. As described above, the probe insertion information may be obtained by using a captured image of the interior of the cooking chamber 230. Upon determining, based on the probe insertion information, that the probe 110 is not inserted in a cooking mode that requires insertion of the probe 110, the user device 1010 may generate and output probe insertion guide information that requests that the probe 110 be inserted into the object to be cooked.

The user device 1010 may periodically receive probe insertion information from the cooking appliance 100. When the probe insertion information of the cooking appliance 100 indicates that the probe 110 is not inserted into the object to be cooked, and then a value of the information is changed to indicate that the probe 110 is inserted into the object to be cooked, the user device 1010 may stop the output of the probe insertion guide information.

In addition, in operation S1104, upon determining, based on the probe insertion information, that the probe 110 is inserted into the object to be cooked, the user device 1020 may output information indicating that the probe 110 is inserted into the object to be cooked.

Next, a process of compensating a probe temperature measurement value will be described.

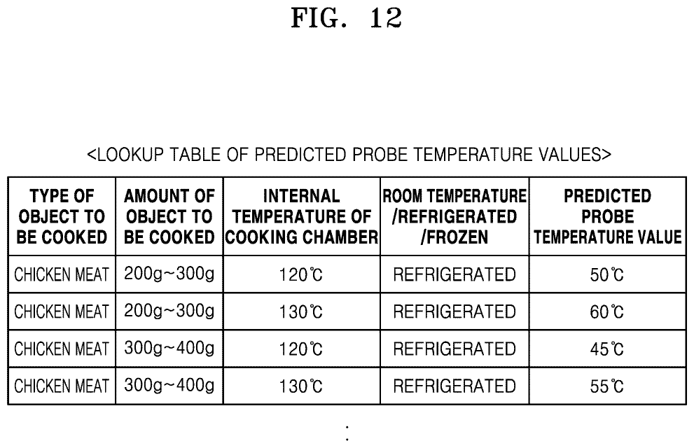

FIG. 12 is a diagram showing predicted probe temperature values according to an embodiment of the present disclosure.

The cooking appliance 100 compensates a probe temperature measurement value by comparing the probe temperature measurement value with a predicted probe temperature value. According to an embodiment of the present disclosure, the predicted probe temperature value is determined based on the type of an object to be cooked, the amount of the object to be cooked, and the internal temperature of the cooking chamber. In addition, according to an embodiment of the present disclosure, the predicted probe temperature value is determined based on the type of an object to be cooked, the amount of the object to be cooked, the internal temperature of the cooking chamber, and a room temperature/refrigerated/frozen state.

FIG. 12 shows a lookup table that stores information about predicted probe temperature values that are defined based on the type of an object to be cooked, the amount of the object to be cooked, the internal temperature of the cooking chamber, and the room temperature/refrigerated/frozen state, according to an embodiment of the present disclosure. According to an embodiment, the cooking appliance 100 may store in advance a lookup table of predicted probe temperature values in the memory 240.

According to an embodiment of the present disclosure, the cooking appliance 100 may receive a lookup table of predicted probe temperature values from the server 1020. Upon receiving information about the type of an object to be cooked and the amount of the object to be cooked through the cooking appliance 100 or the user device 1010, the cooking appliance 100 may request, from the server 1020, a lookup table of predicted probe temperature values corresponding to the type of the object to be cooked and the amount of the object to be cooked. The server 1020 transmits, to the cooking appliance 100, the lookup table of predicted probe temperature values corresponding to the type of the object to be cooked and the amount of the object to be cooked, which is requested from the cooking appliance 100. The cooking appliance 100 stores the lookup table of predicted probe temperature values received from the server 1020, and uses it during a probe temperature compensation operation.

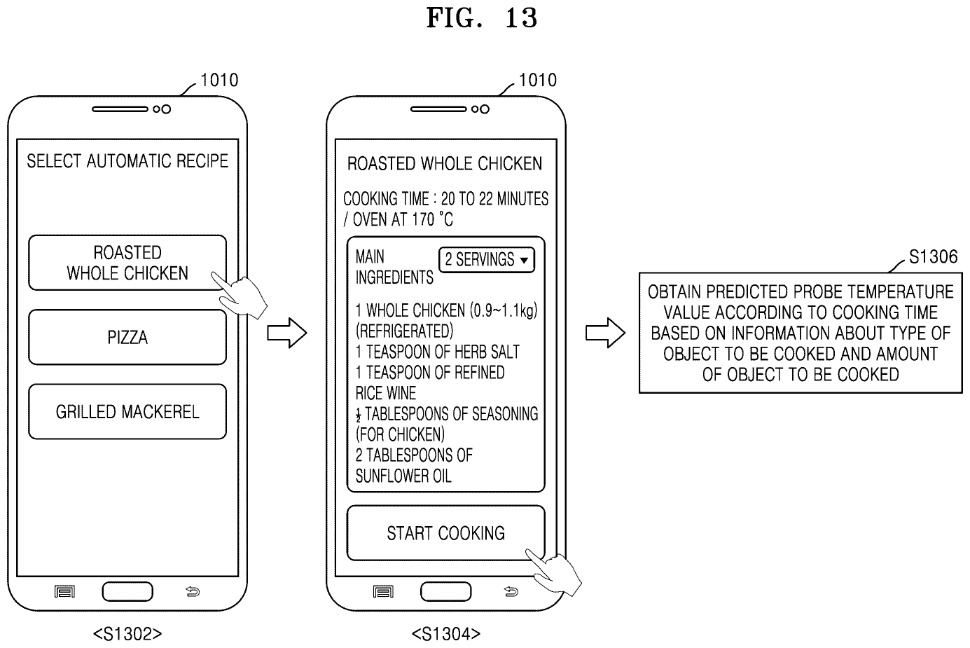

FIG. 13 is a diagram illustrating a process of obtaining a predicted probe temperature value in an automatic cooking mode, according to an embodiment of the present disclosure.

According to an embodiment of the present disclosure, the cooking appliance 100 may operate in an automatic cooking mode in which a cooking operation is automatically performed according to a certain recipe. In the automatic cooking mode, the cooking appliance 100 performs temperature control according to a preset target cooking chamber temperature. In addition, when in an automatic cooking mode using the probe 110, the cooking appliance 100 performs temperature control according to a preset target probe temperature. In addition, in the automatic cooking mode, the cooking appliance 100 may change the target cooking chamber temperature or the target probe temperature over time.

The automatic cooking mode may be selected by the user through the input interface 820 of the cooking appliance 100 or may be selected through an application of the user device 1010. FIG. 13 illustrates an embodiment in which an automatic cooking mode is set through the application of the user device 1010.

First, in operation S1302, the application of the user device 1010 provides a menu for selecting an automatic cooking mode. For example, the application provides a list of at least one automatic cooking item. The user selects a desired automatic cooking item from the list of at least one automatic cooking item.

Next, in operation S1304, the application of the user device 1010 outputs information related to the automatic cooking item selected by the user. For example, the information related to the automatic cooking item includes at least one of a cooking time, a target temperature, types of food ingredients, or amounts of food ingredients. In addition, the information related to the automatic cooking item may further include information about whether to use a probe or probe insertion depth information. The user device 1010, the server 1020, or the cooking appliance 100 stores related information for each automatic cooking item. The cooking appliance 100 may store information related to the automatic cooking item in advance, or may receive it from the server 1020 after the automatic cooking item is selected.

In the automatic cooking mode, the cooking appliance 100 may obtain information about the type of an object to be cooked and information about the amount of the object to be cooked, from food ingredient type information and food ingredient amount information corresponding to the selected automatic cooking item. The cooking appliance 100 sets the type of a main food ingredient (e.g., 1 whole chicken) among a plurality of pieces of food ingredient information as the information about the type of the object to be cooked, and sets the amount of the main food ingredient as the information about the amount of the object to be cooked. Information about the main food ingredient may be defined in the information related to the automatic cooking item. In addition, the information related to the automatic cooking item may include information about a room temperature/refrigerated/frozen state of the main food ingredient. The cooking appliance 100 may obtain information about the room temperature/refrigerated/frozen state of the object to be cooked from the information about the room temperature/refrigerated/frozen state of the main food ingredient included in the information related to the automatic cooking item.

In operation S1304, upon receiving a cooking start request by the user, the user device 1010 transmits the cooking start request to the cooking appliance 100 through the server 1020.

The cooking appliance 100 performs a cooking operation based on the cooking start request. The cooking appliance 100 performs the cooking operation based on automatic cooking item-related information corresponding to the automatic cooking item selected by the user. The cooking appliance 100 performs temperature control based on a target cooking chamber temperature or a target probe temperature of the automatic cooking item. In addition, when the automatic cooking item selected by the user involves the use of the probe 110, the cooking appliance 100 may output a probe insertion request through the output interface 810.

In operation S1306, when the selected automatic cooking item involves the use of the probe 110, the cooking appliance 100 obtains a predicted probe temperature value according to a cooking time based on the information about the type of the object to be cooked and the information about the amount of the object to be cooked. For the automatic cooking item, a predicted probe temperature value according to the cooking time may be stored in advance. While performing automatic cooking of the automatic cooking item, the cooking appliance 100 may obtain the predicted probe temperature value according to the cooking time by using a lookup table of predicted probe temperature values corresponding to each automatic cooking item.

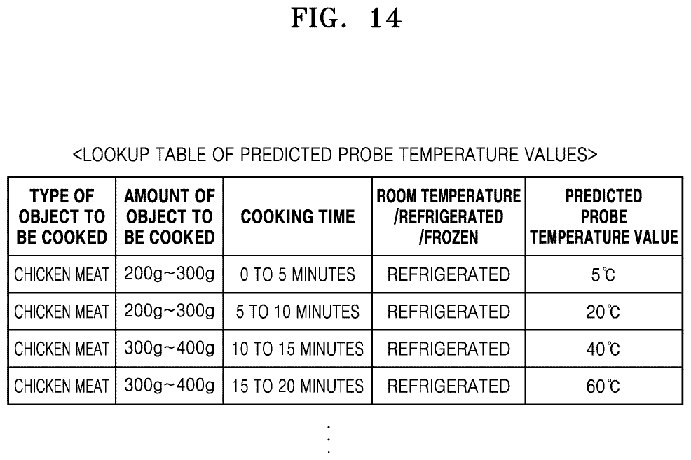

FIG. 14 is a diagram showing a lookup table of predicted probe temperature values corresponding to an automatic cooking item, according to an embodiment of the present disclosure.

According to an embodiment of the present disclosure, for an automatic cooking item that involves the use of the probe 110 for detecting the internal temperature of an object to be cooked, a lookup table of predicted probe temperature values that defines predicted probe temperature values according to cooking times may be defined. According to an embodiment, the lookup table of predicted probe temperature values corresponding to the automatic cooking item may define the predicted probe temperature values by further using, in addition to the cooking times, at least one of information about the type of the object to be cooked, information about an amount of the object to be cooked, or information about a room temperature/refrigerated/frozen state.

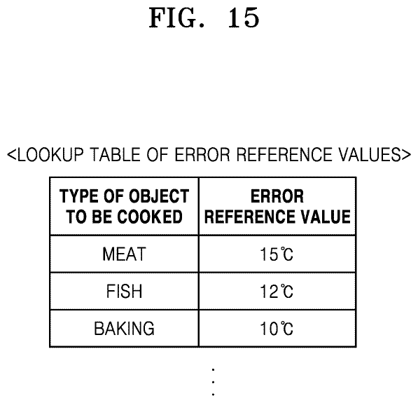

FIG. 15 is a diagram showing a lookup table of error reference values, according to an embodiment of the present disclosure.

According to an embodiment of the present disclosure, an error reference value may be set according to the type of an object to be cooked. The lookup table of error reference values defines error reference values according to types of objects to be cooked. According to an embodiment of the present disclosure, the cooking appliance 100 may store in advance the lookup table of error reference values in the memory 240. In addition, according to an embodiment of the present disclosure, the server 1020 may store a lookup table of error reference values, and the cooking appliance 100 may obtain error reference value information from the server 1020 based on information about the type of an object to be cooked.

For example, as defined in FIG. 15, an error reference value for meat (e.g., beef, pork, or chicken meat) may be set to 15° C., an error reference value for fish may be set to 12° C., and an error reference value for baking may be set to 10° C.

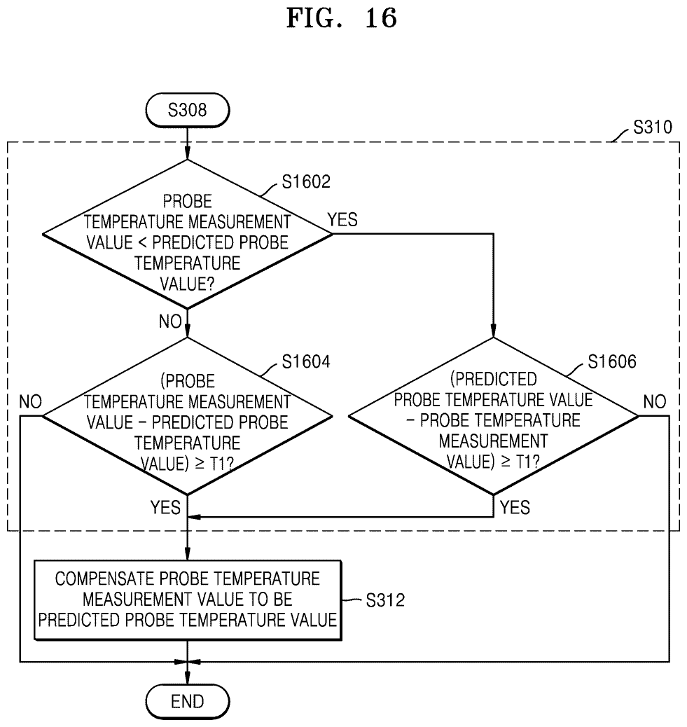

FIG. 16 is a diagram showing a process of compensating a probe temperature measurement value, according to an embodiment of the present disclosure.

According to an embodiment of the present disclosure, during a cooking operation, the cooking appliance 100 obtains a probe temperature measurement value in operation S308, and performs a process of compensating the probe temperature measurement value in operations S310 and S312.

In operation S1602, the cooking appliance 100 determines whether the probe temperature measurement value is less than a predicted probe temperature value. As described above with reference to FIGS. 12 to 14, the predicted probe temperature value may be defined based on a lookup table of predicted probe temperature values.

When the probe temperature measurement value is not less than the predicted probe temperature value, in operation S1604, the cooking appliance 100 determines whether the value obtained by subtracting the predicted probe temperature value from the probe temperature measurement value is greater than or equal to an error reference value T1. As described above with reference to FIG. 15, the error reference value T1 may be defined based on the type of an object to be cooked.

When the probe temperature measurement value is less than the predicted probe temperature value, in operation S1606, the cooking appliance 100 determines whether the value obtained by subtracting the probe temperature measurement value from the predicted probe temperature value is greater than or equal to an error reference value T1.

Upon determining, in operation S1604, that the value obtained by subtracting the predicted probe temperature value from the probe temperature measurement value is greater than or equal to the error reference value T1, or upon determining, in operation S1606, that the value obtained by subtracting the probe temperature measurement value from the predicted probe temperature value is greater than or equal to the error reference value T1, in operation S312, the cooking appliance 100 compensates the probe temperature measurement value by changing the probe temperature measurement value to the predicted probe temperature value.

Upon determining, in operation S1604, that the value obtained by subtracting the predicted probe temperature value from the probe temperature measurement value is less than the error reference value T1, or upon determining, in operation S1606, that the value obtained by subtracting the probe temperature measurement value from the predicted probe temperature value is less than the error reference value T1, the cooking appliance 100 uses the probe temperature measurement value as it is without compensating it.

The cooking appliance 100 may periodically obtain a probe temperature measurement value. Each time a probe temperature measurement value is obtained, the cooking appliance 100 may repeat operations S1602, S1604, S1606, and S312.

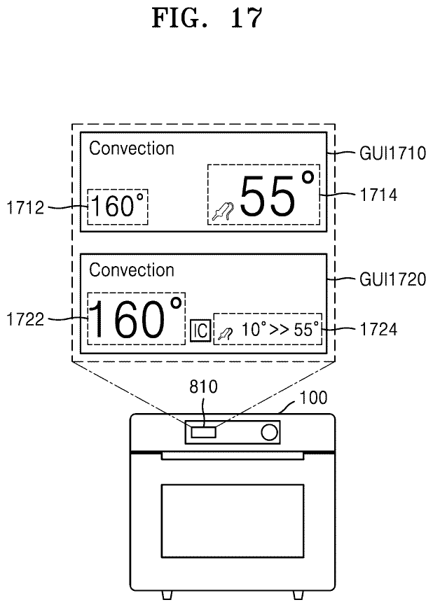

FIG. 17 is a diagram illustrating the cooking appliance 100 outputting a probe temperature detection value, according to an embodiment of the present disclosure.

According to an embodiment of the present disclosure, the cooking appliance 100 outputs a cooking chamber temperature measurement value and a probe temperature measurement value, through the output interface 810. According to an embodiment of the present disclosure, when the probe temperature measurement value is compensated by the cooking appliance 100, the cooking appliance 100 may output information that the probe temperature measurement value has been compensated.

GU1710 illustrates a graphical user interface (GUI) view that is output through the output interface 810 when the probe temperature measurement value is not compensated. When the probe temperature measurement value is not compensated, the cooking appliance 100 outputs cooking chamber temperature measurement value information 1712 and probe temperature measurement value information 1714, through the output interface 810. The cooking appliance 100 may add a predetermined icon or text to the probe temperature measurement value information 1714 so as to output the probe temperature measurement value information 1714 to be distinguished from an internal temperature value of the cooking chamber.

GUI1720 illustrates a GUI view that is output through the output interface 810 when the probe temperature measurement value is compensated. When the probe temperature measurement value is compensated, the cooking appliance 100 outputs cooking chamber temperature measurement value information 1722 and probe temperature measurement value information 1724, through the output interface 810. The probe temperature measurement value 1724 of GUI1720 includes probe temperature measurement value information before compensation (e.g., 10° C.) and probe temperature measurement value information after compensation (e.g., 55° C.). According to an embodiment of the present disclosure, when the probe temperature measurement value is compensated, information that the probe temperature measurement value has been compensated is provided to the user, such that the user may recognize that the probe temperature measurement value is different from the predicted probe temperature value, and that the current probe temperature measurement value is being compensated.

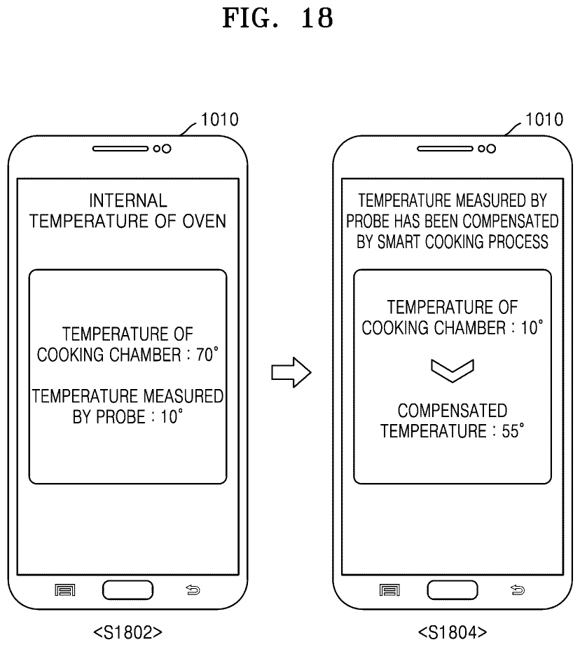

FIG. 18 is a diagram illustrating a probe temperature measurement value being output through a user device, according to an embodiment of the present disclosure.

According to an embodiment of the present disclosure, a cooking chamber temperature measurement value and a probe temperature measurement value may be output through the user device 1010. For example, in operation S1802, the user device 1010 outputs a cooking chamber temperature measurement value and a probe temperature measurement value, during a cooking operation. The cooking appliance 100 periodically transmits the cooking chamber temperature measurement value and the probe temperature measurement value to the server 1020, during the cooking operation. The user device 1010 may periodically receive a cooking chamber temperature measurement value and a probe temperature measurement value from the server 1020, and output the cooking chamber temperature measurement value and the probe temperature measurement value through an application.

According to an embodiment of the present disclosure, when the probe temperature measurement value is compensated, the user device 1010 outputs information that the probe temperature measurement value has been compensated. When the probe temperature measurement value is compensated, the cooking appliance 100 transmits, to the server 1020, information that the probe temperature measurement value has been compensated, the probe temperature measurement value before compensation, and the temperature measurement value after compensation. The user device 1010 receives, from the server 1020, the information that the probe temperature measurement value has been compensated, the probe temperature measurement value before compensation, and the temperature measurement value after compensation. When the probe temperature measurement value is compensated, in operation S1804, the user device 1010 may output information that the probe temperature measurement value has been compensated, the probe temperature measurement value before compensation, and the probe temperature measurement value after compensation, through the application.

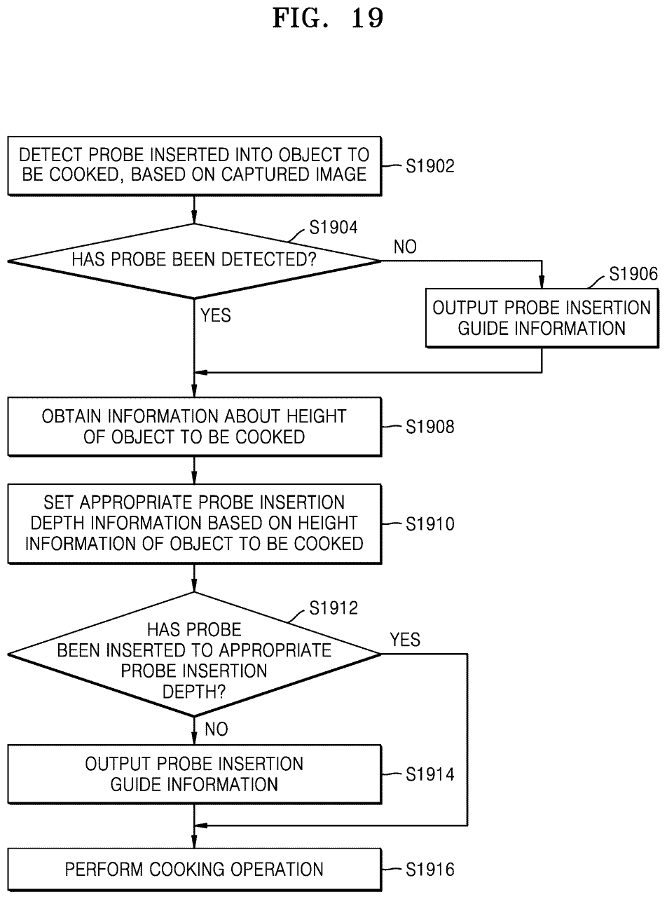

FIG. 19 is a diagram illustrating a process of outputting probe insertion guide information, according to an embodiment of the present disclosure.

According to an embodiment of the present disclosure, in a probe mode using the probe 110, the cooking appliance 100 detects whether the probe 110 is inserted into an object to be cooked, and outputs probe insertion guide information. In addition, the cooking appliance 100 determines whether the probe 110 is inserted into the object to be cooked to an appropriate depth, and when the probe 110 is not inserted to the appropriate depth, the cooking appliance 100 outputs probe insertion guide information including information about an appropriate insertion depth of the probe 110.

First, in operation S1902, the cooking appliance 100 detects the probe 110 inserted into the object to be cooked, based on an image captured by the camera 220. The cooking appliance 100 may detect the probe 110 from the captured image by recognizing the probe identifier 610 from the captured image.

Next, in operation S1904, the cooking appliance 100 determines whether the probe 110 has been detected from the captured image. When the probe identifier 610 is recognized from the captured image, the cooking appliance 100 determines that the probe 110 has been detected, and when the probe identifier 610 is not recognized, determines that the probe 110 has not been detected.

When the probe 110 is not detected from the captured image, in operation S1906, the cooking appliance 100 may output probe insertion guide information that guides the user to insert the probe 110 into the object to be cooked.

When the probe 110 is detected from the captured image, or when the output of the probe insertion guide information is completed, in operation S1908, the cooking appliance 100 obtains height information of the object to be cooked. The height information of the object to be cooked refers to height information of the object to be cooked when it is placed on the bottom.

According to an embodiment of the present disclosure, the height information of the object to be cooked is obtained based on information about an amount of the object to be cooked or height information of the object to be cooked that is input by the user. When the cooking appliance 100 obtains the information about the amount of the object to be cooked, the cooking appliance 100 predicts height information of the object to be cooked, based on the type of the object to be cooked and the amount of the object to be cooked.

In addition, according to an embodiment of the present disclosure, the height information of the object to be cooked may be obtained by using the camera 220 inside the cooking chamber 230. The cooking appliance 100 may include at least one camera 220 on a side surface of the cooking chamber 230. The cooking appliance 100 may obtain the height information of the object to be cooked based on an image captured by using the camera 220 on the side surface. The cooking appliance 100 may recognize the object to be cooked from the image captured from the side surface of the object to be cooked, and obtain the height information of the object to be cooked.

Next, in operation S1910, the cooking appliance 100 sets appropriate probe insertion depth information based on the height information of the object to be cooked. The appropriate probe insertion depth information is determined based on the height information of the object to be cooked. According to an embodiment of the present disclosure, the appropriate probe insertion depth information may be stored in a lookup table in advance. The cooking appliance 100 may obtain the appropriate probe insertion depth information from the lookup table based on the height information of the object to be cooked.

Next, in operation S1912, the cooking appliance 100 determines whether the probe 110 has been inserted into the object to be cooked to an appropriate probe insertion depth. The cooking appliance 100 recognizes one or more depth identifiers 620a, 620b, 620c, 620d, 620e, and 620f of the probe 110 from the captured image. The cooking appliance 100 recognizes a probe insertion depth based on the recognized depth identifiers 620a, 620b, 620c, 620d, 620e, and 620f. For example, when the top two depth identifiers 620a and 620b are recognized from the captured image, the cooking appliance 100 determines that the probe 110 has been inserted to a depth between the identifiers 620b and 620c. The cooking appliance 100 compares the probe insertion depth with the appropriate probe insertion depth to determine whether the probe 110 has been inserted to the appropriate probe insertion depth.

Upon determining that the probe 110 has not been inserted to the appropriate probe insertion depth, in operation S1914, the cooking appliance 100 outputs probe insertion guide information. The cooking appliance 100 may output probe insertion guide information including the appropriate probe insertion depth information. According to an embodiment of the present disclosure, the cooking appliance 100 outputs the probe insertion guide information through the output interface 810. In addition, according to an embodiment of the present disclosure, the cooking appliance 100 outputs the probe insertion guide information through the application of the user device 1010.

Upon determining, in operation S1912, that the probe 110 has been inserted to the appropriate probe insertion depth, or when the probe insertion guide information is output in operation S1914, the cooking appliance 100 performs a cooking operation in operation S1916. According to an embodiment of the present disclosure, the cooking operation may be initiated based on a separate user input.

According to an embodiment of the present disclosure, the server 1020 or the user device 1010 may perform the operations of S1902, S1904, S1906, S1908, S1910, S1912, and S1914. In this case, the cooking appliance 100 transmits the captured image to the server 1020 or the user device 1010. The server 1020 or the user device 1010 may perform the operations of S1902, S1904, S1906, S1908, S1910, S1912, and S1914, based on the captured image received from the cooking appliance 100.

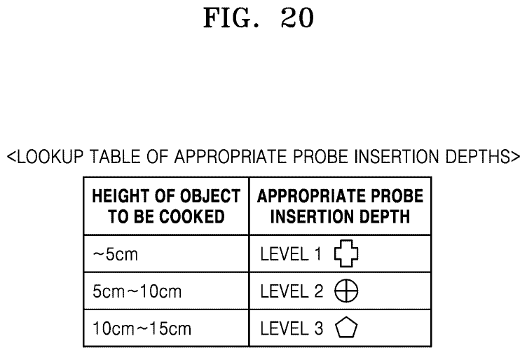

FIG. 20 is a diagram illustrating a lookup table of appropriate probe insertion depths, according to an embodiment of the present disclosure.

According to an embodiment of the present disclosure, an appropriate probe insertion depth is defined based on the height of an object to be cooked. The lookup table of appropriate probe insertion depths defines appropriate probe insertion depths according to heights of objects to be cooked. For example, in the lookup table of appropriate probe insertion depths, an appropriate probe insertion depth for an object to be cooked having a height of less than 5 cm is defined as level 1, an appropriate probe insertion depth for an object to be cooked having a height of greater than or equal to 5cm but less than 10 cm is defined as level 2, and an appropriate probe insertion depth for an object to be cooked having a height of greater than or equal to 10 cm but less than 15cm is defined as level 3.

According to an embodiment of the present disclosure, the lookup table of appropriate probe insertion depths is stored in the memory 240 of the cooking appliance 100. The processor 210 may obtain appropriate probe insertion depth information according to the height of the object to be cooked by using the lookup table of appropriate probe insertion depths stored in the memory 240.

In addition, according to an embodiment of the present disclosure, the lookup table of appropriate probe insertion depths is stored in the server 1020. The cooking appliance 100 transmits, to the server 1020, an appropriate probe insertion depth request including height information of the object to be cooked, and receives appropriate probe insertion depth information from the server 1020.

In addition, according to an embodiment of the present disclosure, in the automatic cooking mode, an appropriate probe insertion depth may be defined according to an automatic cooking item. According to an embodiment of the present disclosure, the lookup table of appropriate probe insertion depths defines appropriate probe insertion depth information according to the automatic cooking item. In addition, according to an embodiment of the present disclosure, in the automatic cooking mode, food amount information of the automatic cooking item (e.g., 1 serving, 2 servings, 200 g of meat, or 400 g of meat). The appropriate probe insertion depth information may be defined based on the automatic cooking item and the food amount information.

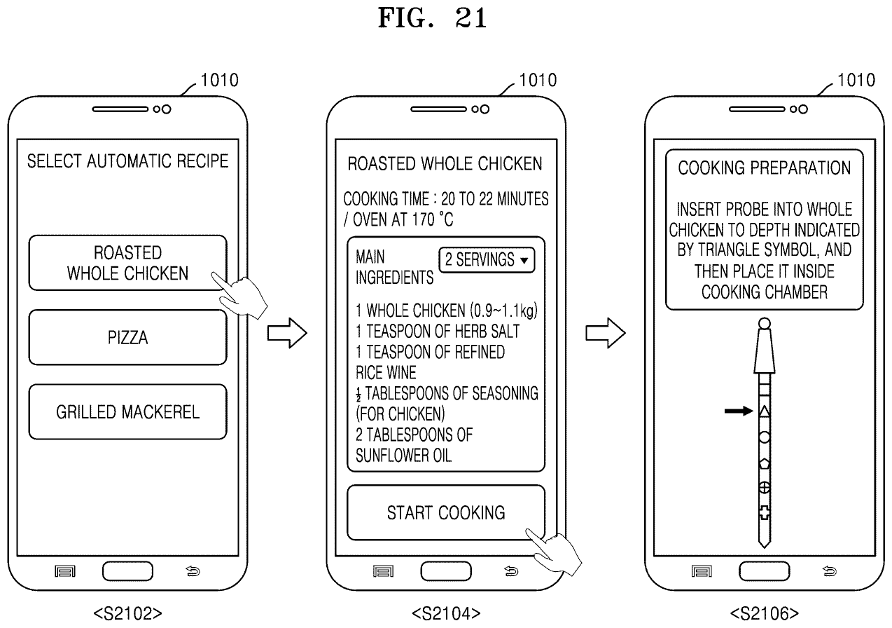

FIG. 21 is a diagram illustrating a process of outputting probe insertion guide information in an automatic cooking mode, according to an embodiment of the present disclosure.

According to an embodiment of the present disclosure, in the automatic cooking mode, the cooking appliance 100 or the user device 1010 may output probe insertion guide information including appropriate probe insertion depth information. An operation in which the user device 1010 outputs probe insertion guide information will be described with reference to FIG. 21.

In operation S2102, the user device 1010 provides a list of automatic cooking items that may be cooked in the automatic cooking mode. The user device 1010 receives a user input for selecting one automatic cooking item from the list of automatic cooking items.

Next, in operation S2104, the user device 1010 provides information related to the automatic cooking item. For example, the user device 1010 provides information about at least one of the name, cooking time, target cooking chamber temperature, main ingredients, or food amount of the automatic cooking item. The user device 1010 receives a user input requesting to start cooking of the automatic cooking item.

Next, in operation S2106, the user device 1010 provides probe insertion guide information. The user device 1010 obtains appropriate probe insertion height information based on the type and food amount of the automatic cooking item. The user device 1010 outputs probe insertion guide information including the appropriate probe insertion height information.

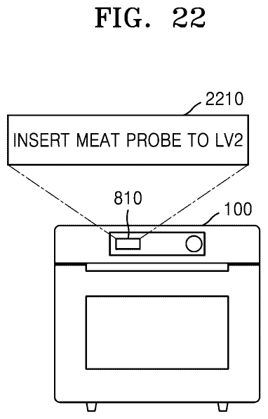

FIG. 22 is a diagram illustrating a cooking appliance providing probe insertion guide information, according to an embodiment of the present disclosure.

According to an embodiment of the present disclosure, the cooking appliance 100 outputs probe insertion guide information including appropriate probe insertion depth information, through the output interface 810. The cooking appliance 100 may output probe insertion guide information 2210 that guides the user to insert the probe 110 into an object to be cooked up to level 2.

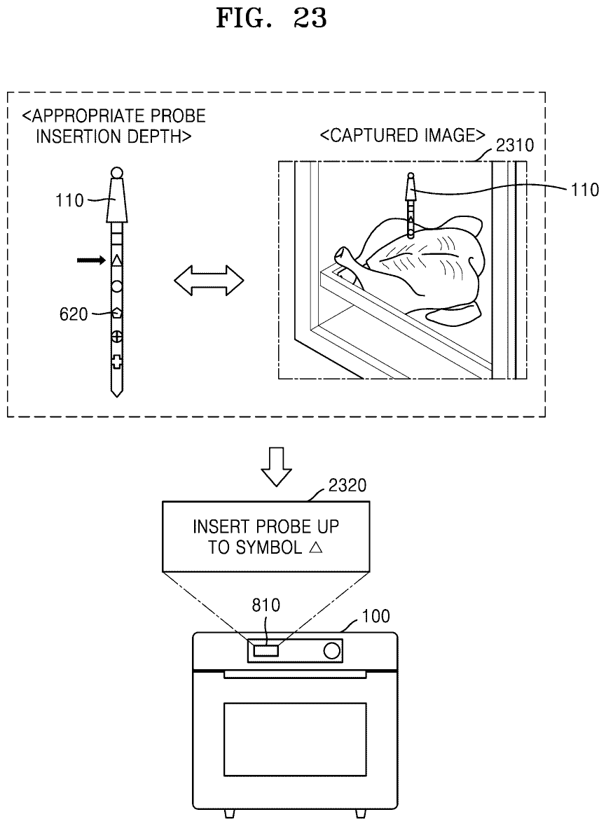

FIG. 23 is a diagram illustrating a process in which a cooking appliance outputs probe insertion guide information, according to an embodiment of the present disclosure.

According to an embodiment of the present disclosure, probe insertion guide information is output by using attributes of the depth identifiers 620 that are distinguishable by the naked eye. The attributes of the depth identifiers 620 that are distinguishable by the naked eye may include at least one of shape, color, text, number, or scale mark position. In the embodiment of FIG. 23, the depth identifiers 620 have different shapes and colors.

As illustrated in FIG. 23, a case will be described as an example, in which the appropriate probe insertion depth is the depth indicated by the second triangle symbol from the top, and a probe insertion depth recognized from a captured image is the depth indicated by the third circle symbol from the top. In the example of FIG. 23, the probe insertion depth recognized from a captured image 2310 corresponds to the third circle symbol, but the appropriate probe insertion depth corresponds to the second triangle symbol, and thus, the probe insertion depth and the appropriate probe insertion depth are different from each other. In this case, the cooking appliance 100 outputs probe insertion guide information 2320 instructing to insert the probe 110 up to the second triangle symbol. The cooking appliance 100 may output the probe insertion guide information including an identifier identical to the attribute of the depth identifier 620 provided on an outer portion of the probe 110. For example, the cooking appliance 100 outputs the probe insertion guide information 2310 including an identifier having the same shape as the yellow-green triangle symbol provided on an outer portion of the probe 110.

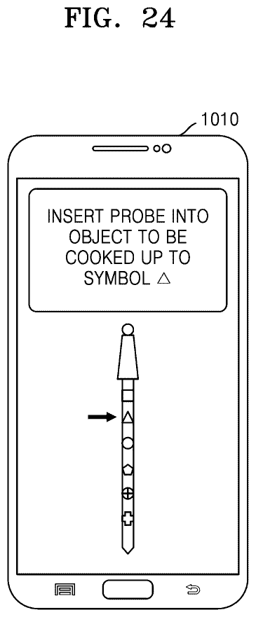

FIG. 24 is a diagram illustrating probe insertion guide information being output through a user device, according to an embodiment of the present disclosure.

According to an embodiment of the present disclosure, the user device 1010 outputs probe insertion guide information by using attributes of the depth identifiers 620 that are distinguishable by the naked eye.

In FIG. 24, as described above with reference to FIG. 23, a case will be described as an example, in which the appropriate probe insertion depth is the depth indicated by the second triangle symbol from the top, and a probe insertion depth recognized from a captured image is the depth indicated by the third circle symbol from the top. In the example of FIG. 23, the probe insertion depth recognized from the captured image 2310 corresponds to the third circle symbol, but the appropriate probe insertion depth corresponds to the second triangle symbol, and thus, the probe insertion depth and the appropriate probe insertion depth are different from each other. In this case, the user device 1010 outputs the probe insertion guide information 2310 instructing to insert the probe 110 up to the second triangle symbol. The user device 1010 may output the probe insertion guide information including an identifier identical to the attribute of the depth identifier 620 provided on an outer portion of the probe 110. For example, the cooking appliance 100 outputs probe insertion guide information including an identifier having the same shape as the yellow-green triangle symbol provided on an outer portion of the probe 110.

FIG. 25 is a diagram illustrating a structure of a cooking appliance according to an embodiment of the present disclosure.

A cooking appliance 2500 according to an embodiment of the present disclosure includes a sensor 2510, an output interface 2520, an input interface 2530, a memory 2540, a communication module 2550, a cooking module 2560, a camera 2570, a power module 2580, and a processor 2590. The cooking appliance 2500 may be configured by various combinations of the components illustrated in FIG. 25, and the components illustrated in FIG. 25 are not essential components.

The cooking appliance 2500 of FIG. 25 corresponds to the cooking appliance 100 described above with reference to FIGS. 2 and 8. The camera 2570 corresponds to the camera 220 described above with reference to FIG. 2. The memory 2540 corresponds to the memory 240 described above with reference to FIG. 2. The communication module 2550 corresponds to the communication module 250 described above with reference to FIG. 2. The processor 2590 corresponds to the processor 210 described above with reference to FIG. 2. A temperature sensor 2511 corresponds to the temperature sensor 830 described above with reference to FIG. 8. The output interface 2520 corresponds to the output interface 810 described above with reference to FIG. 8. The input interface 2530 corresponds to the input interface 820 described above with reference to FIG. 8. A cooking chamber 2561 corresponds to the cooking chamber 230 described above with reference to FIG. 2.

The sensor 2510 may include various types of sensors, and may include, for example, the temperature sensor 2511 and a smoke sensor 2512.

The output interface 2520 may include at least one of a display 2521 or a speaker 2522, or a combination thereof. The output interface 2520 outputs various notifications, messages, information, and the like generated by the processor 2590.

The input interface 2530 may include a key 2531, a touch pad 2532, a dial 2533, and the like. The input interface 2530 receives a user input and delivers the user input to the processor 2590.

The memory 2540 stores various pieces of information, data, instructions, programs, and the like necessary for the operation of the cooking appliance 2500. The memory 2540 may include at least one of volatile memory or nonvolatile memory, or a combination thereof. The memory 2540 may include at least one of a flash memory-type storage medium, a hard disk-type storage medium, a multimedia card micro-type storage medium, a card-type memory (e.g., SD or XD memory), RAM, SRAM, ROM, EEPROM, PROM, magnetic memory, a magnetic disk, and an optical disc. In addition, the cooking appliance 2500 may operate a web storage or a cloud server that performs a storage function on the Internet.

The communication module 2550 may include at least one of a short-range communication module 2552 or a mobile communication module 2554, or a combination thereof. The communication module 2550 may include at least one antenna for wireless communication with other devices.

The short-range communication module 2552 may include, but is not limited to, a Bluetooth communication unit, a BLE communication unit, an NFC unit, a WLAN (e.g., Wi-Fi) communication unit, a Zigbee communication unit, an IrDA communication unit, a WFD communication unit, a UWB communication unit, an Ant+ communication unit, a microwave (uWave) communication unit, etc.

The mobile communication module 2554 transmits and receives radio signals with at least one of a base station, an external terminal, or a server on a mobile communication network. Here, the radio signals may include a voice call signal, a video call signal, or various types of data according to text/multimedia message transmission and reception.

The cooking module 2560 includes the cooking chamber 2561, a ventilation fan 2562, a steam discharge module 2563, a door 2564, the heating module 2565, and the like. The cooking chamber 2561 accommodates food ingredients. The ventilation fan 2562 circulates internal air of the cooking chamber 2561. The steam discharge module 2563 discharges steam into the cooking chamber 2561. The door 2564 opens and closes the cooking chamber 2561. The heating module 2565 supplies heat to the cooking chamber 2561 to regulate the internal temperature of the cooking chamber 2561.

The camera 2570 photographs the interior of the cooking chamber 2561.

The power module 2580 supplies power to the cooking appliance 2500. The power module 2580 includes a battery, a power drive circuit, a converter, a transformer circuit, and the like. The power module 2580 is connected to an external power source to receive power.

The processor 2590 controls the overall operation of the cooking appliance 2500. The processor 2590 may execute a program stored in the memory 2540 to control the components of the cooking appliance 2500.

According to an embodiment of the present disclosure, the processor 2590 may include a separate NPU configured to perform an operation of a machine learning model. In addition, the processor 2590 may include a CPU, a GPU, and the like.

The processor 2590 may perform operations of the cooking appliance 2500, such as controlling an operation mode.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment, methods according to various embodiments disclosed herein may be included in a computer program product and then provided. The computer program product may be traded as commodities between sellers and buyers. The computer program product may be distributed in the form of a machine-readable storage medium (e.g., a compact disc ROM (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

According to an aspect of an embodiment of the present disclosure, a method of controlling a cooking appliance is provided. The method of controlling a cooking appliance includes obtaining an image captured by a camera arranged inside a cooking chamber of the cooking appliance (S302). In addition, the method of controlling a cooking appliance includes detecting, based on the captured image, a probe inserted into an object to be cooked that is placed inside the cooking chamber (S304). In addition, the method of controlling a cooking appliance includes performing a cooking operation (S306). In addition, the method of controlling a cooking appliance includes obtaining a probe temperature measurement value measured by the probe (S308). In addition, the method of controlling a cooking appliance includes determining whether a difference between a predicted probe temperature value, which is determined based on a type and an amount of the object to be cooked, and the measured probe temperature measurement value is greater than or equal to an error reference value (S310). In addition, the method of controlling a cooking appliance includes, based on the difference between the predicted probe temperature value and the probe temperature measurement value being greater than or equal to the error reference value, compensating the probe temperature measurement value (S312).

In addition, according to an embodiment of the present disclosure, the method of controlling a cooking appliance further includes: recognizing, from a captured image of the probe, a plurality of depth identifiers that respectively correspond to a plurality of insertion depths of the probe and are provided on a surface of the probe; identifying an insertion depth of the probe based on the plurality of depth identifiers that are recognized; and based on the insertion depth of the probe being different from a preset appropriate probe insertion depth, outputting guide information for guiding through adjustment of the insertion depth of the probe to the appropriate probe insertion depth.

In addition, according to an embodiment of the present disclosure, each of the plurality of depth identifiers includes an identifier that is identifiable by a user with the naked eye, and a coded visual code identifier recognizable by the cooking appliance from the captured image, the recognizing of the plurality of depth identifiers includes recognizing the plurality of depth identifiers by using the visual code identifier of each of the plurality of depth identifiers, and the outputting of the guide information includes outputting the guide information by using the identifier of each of the plurality of depth identifiers that is identifiable with the naked eye.

In addition, according to an embodiment of the present disclosure, the method of controlling a cooking appliance further includes: obtaining height information of the object to be cooked; and setting the appropriate probe insertion depth based on the height information of the object to be cooked.

In addition, according to an embodiment of the present disclosure, the obtaining of the height information of the object to be cooked includes obtaining the height information of the object to be cooked based on a user input including amount information or height information of the object to be cooked.

In addition, according to an embodiment of the present disclosure, the obtaining of the height information of the object to be cooked includes obtaining the height information of the object to be cooked based on the image captured by the camera arranged inside the cooking chamber.

In addition, according to an embodiment of the present disclosure, the error reference value is determined based on the type of the object to be cooked.

In addition, according to an embodiment of the present disclosure, the method of controlling a cooking appliance further includes measuring an internal temperature of the cooking chamber, and the predicted probe temperature value is defined based on the type and the amount of the object to be cooked, and the measured internal temperature of the cooking chamber.

In addition, according to an embodiment of the present disclosure, the method of controlling a cooking appliance further includes: receiving information about the type and the amount of the object to be cooked; and performing, based on the compensated probe temperature measurement value, an automatic cooking operation corresponding to the object to be cooked.

In addition, according to an embodiment of the present disclosure, the predicted probe temperature value is defined based on the type of the object to be cooked, the amount of the object to be cooked, and a cooking time.

In addition, according to an embodiment of the present disclosure, the detecting of the probe includes: setting a cooking mode of the cooking appliance to a probe mode in which an internal temperature of the object to be cooked is measured by using the probe; and based on the cooking mode being set to the probe mode, detecting, from the captured image, the probe inserted into the object to be cooked that is placed inside the cooking chamber.

In addition, according to an embodiment of the present disclosure, the detecting of the probe includes: recognizing a probe identifier provided in the probe; and based on recognizing the probe identifier, detecting that the probe is present.

In addition, according to an embodiment of the present disclosure, the detecting of the probe includes: recognizing the probe connected to the cooking appliance by wire or wirelessly; and
based on recognizing the probe connected to the cooking appliance, detecting that the probe is present.

In addition, according to an embodiment of the present disclosure, the predicted probe temperature value is defined based on the type of the object to be cooked, the amount of the object to be cooked, and a room temperature/refrigerated/frozen state of the object to be cooked.

In addition, according to an embodiment of the present disclosure, the error reference value is determined based on the type of the object to be cooked.

In addition, according to an aspect of an embodiment of the present disclosure, a cooking appliance 100 is provided. The cooking appliance 100 includes a cooking chamber 230 that accommodates an object to be cooked. In addition, the cooking appliance 100 includes a camera 220 configured to photograph an interior of the cooking chamber. In addition, the cooking appliance 100 includes a communication module 250. In addition, the cooking appliance 100 includes a memory 240 storing at least one instruction. In addition, the cooking appliance 100 includes at least one processor 210. The at least one processor 210 executes the at least one instruction to obtain an image captured by the camera 220. In addition, the at least one processor 210 executes the at least one instruction to detect, based on the captured image, a probe 110 inserted into the object to be cooked that is placed inside the cooking chamber. In addition, the at least one processor 210 executes the at least one instruction to perform a cooking operation. In addition, the at least one processor 210 executes the at least one instruction to obtain, through the communication module 250, a probe temperature measurement value measured by the probe 110. In addition, the at least one processor 210 executes the at least one instruction to determine whether a difference between a predicted probe temperature value, which is determined based on a type and an amount of the object to be cooked, and the measured probe temperature measurement value is greater than or equal to an error reference value. In addition, the at least one processor 210 executes the at least one instruction to compensate, based on the difference between the predicted probe temperature value and the measured probe temperature measurement value being greater than or equal to the error reference value, the probe temperature measurement value.

In addition, according to an embodiment of the present disclosure, the cooking appliance 100 further includes an output interface 810. The at least one processor 210 executes the at least one instruction to recognize, from a captured image of the probe 110, a plurality of depth identifiers respectively that correspond to a plurality of insertion depths of the probe 110 and are provided on a surface of the probe 110, identify an insertion depth of the probe 110 based on the plurality of depth identifiers 620 that are recognized, and based on the insertion depth of the probe 110 being different from a preset appropriate probe insertion depth, output, through the output interface, guide information for guiding through adjustment of the insertion depth of the probe to the appropriate probe insertion depth.

In addition, according to an embodiment of the present disclosure, each of the plurality of depth identifiers 620 includes an identifier that is identifiable by a user with the naked eye, and a coded visual code identifier 640 recognizable by the cooking appliance from the captured image, and the at least one processor 210 executes the at least one instruction to recognize the plurality of depth identifiers 620 by using the visual code identifier 640 of each of the plurality of depth identifiers, and output the guide information by using the identifier of each of the plurality of depth identifiers 620 that is identifiable with the naked eye.

In addition, according to an embodiment of the present disclosure, the at least one processor 210 executes the at least one instruction to obtain height information of the object to be cooked, and set the appropriate probe insertion depth based on the height information of the object to be cooked.

In addition, according to an aspect of an embodiment of the present disclosure, provided is a computer-readable recording medium having recorded thereon a program for causing a computer to perform the method of controlling a cooking appliance.

1. A method of controlling a cooking appliance, the method comprising:
obtaining an image captured by a camera arranged inside a cooking chamber of the cooking appliance;
detecting, based on the captured image, a probe inserted into an object to be cooked that is placed inside the cooking chamber;
performing a cooking operation on the object to be cooked;
obtaining a probe temperature measurement value measured by the probe;
determining whether a difference in value between a predicted probe temperature value, which is determined based on a type and an amount of the object to be cooked, and the measured probe temperature measurement value is greater than or equal to an error reference value; and
based on the difference in value between the predicted probe temperature value and the probe temperature measurement value being greater than or equal to the error reference value, compensating the probe temperature measurement value.

2. The method of claim 1, further comprising:
recognizing, from the image, a plurality of depth identifiers that respectively correspond to a plurality of insertion depths on a surface of the probe;
identifying an insertion depth of the probe based on the plurality of depth identifiers that are recognized; and
based on the insertion depth of the probe being different from a preset appropriate probe insertion depth, outputting guide information to guide adjustment of the insertion depth of the probe to the preset appropriate probe insertion depth.

3. The method of claim 2, wherein the plurality of depth identifiers comprises an identifier that is identifiable by a user with a naked eye, and a coded visual code identifier recognizable by the cooking appliance from the captured image,
the recognizing of the plurality of depth identifiers comprises recognizing the plurality of depth identifiers by using a respective visual code identifier of the plurality of depth identifiers, and
the outputting of the guide information comprises outputting the guide information by using a respective identifier of the plurality of depth identifiers that is identifiable with the naked eye.

4. The method of claim 2, further comprising:
obtaining height information of the object to be cooked; and
wherein the preset appropriate probe insertion depth is set based on the height information of the object to be cooked.

5. The method of claim 4, wherein the height information of the object to be cooked is obtained based on a user input comprising amount information or height information of the object to be cooked.

6. The method of claim 4, wherein the height information of the object to be cooked is obtained based on the image captured by the camera arranged inside the cooking chamber.

7. The method of claim 1, wherein the error reference value is determined based on the type of the object to be cooked.

8. The method of claim 1, further comprising measuring an internal
temperature of the cooking chamber,
wherein the predicted probe temperature value is defined based on the type and the amount of the object to be cooked, and the measured internal temperature of the cooking chamber.

9. The method of claim 1, further comprising:
receiving information about the type and the amount of the object to be cooked; and
performing, based on the compensated probe temperature measurement value, an automatic cooking operation corresponding to the object to be cooked.

10. The method of claim 9, wherein the predicted probe temperature value is defined based on the type of the object to be cooked, the amount of the object to be cooked, and a cooking time.

11. The method of claim 1, wherein the detecting of the probe comprises:
setting a cooking mode of the cooking appliance to a probe mode in which an internal temperature of the object to be cooked is measured by using the probe; and
based on the cooking mode being set to the probe mode, detecting, from the captured image, the probe inserted into the object to be cooked that is placed inside the cooking chamber.

12. The method of claim 1, wherein the detecting of the probe comprises:
recognizing a probe identifier provided in the probe; and
based on recognizing the probe identifier, detecting that the probe is present.

13. The method of claim 1, wherein the detecting of the probe comprises:
recognizing the probe connected to the cooking appliance by wire or wirelessly; and
based on recognizing the probe connected to the cooking appliance, detecting that the probe is present.

14. A cooking appliance comprising:
a cooking chamber that accommodates an object to be cooked;
a camera configured to photograph an interior of the cooking chamber;
a communication module;
a memory to store at least one instruction; and
at least one processor configured to execute the at least one instruction to:
obtain an image captured by the camera,
detect, based on the captured image, a probe inserted into the object to be cooked that is placed inside the cooking chamber,
perform a cooking operation on the object to be cooked,
obtain, through the communication module, a probe temperature measurement value measured by the probe,
determine whether a difference in value between a predicted probe temperature value, which is determined based on a type and an amount of the object to be cooked, and the measured probe temperature measurement value is greater than or equal to an error reference value, and
compensate, based on the difference in value between the predicted probe temperature value and the measured probe temperature measurement value being greater than or equal to the error reference value, the probe temperature measurement value.

15. The cooking appliance of claim 14, further comprising an output interface, and wherein the at least one processor is configured to execute the at least one instruction further to:
recognize, from the image, a plurality of depth identifiers that respectively correspond to a plurality of insertion depths on a surface of the probe;
identify an insertion depth of the probe based on the plurality of depth identifiers that are recognized; and
based on the insertion depth of the probe being different from a preset appropriate probe insertion depth, output guide information to guide adjustment of the insertion depth of the probe to the preset appropriate probe insertion depth through the output interface.

16. The cooking appliance of claim 15, wherein the plurality of depth identifiers comprises an identifier that is identifiable by a user with a naked eye, and a coded visual code identifier recognizable by the cooking appliance from the captured image, and
the at least one processor is configured to execute the at least one instruction further to:
recognize the plurality of depth identifiers by using a respective visual code identifier of the plurality of depth identifiers, and
output the guide information by using a respective identifier of the plurality of depth identifiers that is identifiable with the naked eye.

17. The cooking appliance of claim 15, wherein the at least one processor is configured to execute the at least one instruction further to:
obtain height information of the object to be cooked; and
set the preset appropriate probe insertion depth based on the height information of the object to be cooked.

18. The cooking appliance of claim 14, wherein the at least one processor is configured to execute the at least one instruction further to:
receive information about the type and the amount of the object to be cooked; and
perform, based on the compensated probe temperature measurement value, an automatic cooking operation corresponding to the object to be cooked.

19. The cooking appliance of claim 14, wherein the at least one processor is configured to execute the at least one instruction further to:
set a cooking mode of the cooking appliance to a probe mode in which an internal temperature of the object to be cooked is measured by using the probe; and
detect, based on the cooking mode being set to the probe mode, from the captured image, the probe inserted into the object to be cooked that is placed inside the cooking chamber.

20. A computer-readable recording medium having recorded thereon a program for causing a computer to perform the method of claim 1.
